(19) United States
(12) Patent Application Publication
(10) Pub. No.: US 2009/0006040 A1
(43) Pub. Date: Jan. 1, 2009

(54) Systems and Methods for Representing Protein Binding Sites and Identifying Molecules with Biological Activity

(76) Inventor: Peter HRNCIAR, Hamden, CT (US)

Correspondence Address: WILMERHALE/BOSTON, 60 STATE STREET, BOSTON, MA, 02109, US

(21) Appl. No.: 12/126,222

(22) Filed: May 23, 2008

Related U.S. Application Data
(60) Provisional application No. 60/939,967, filed on May 24, 2007.
(60) Provisional application No. 60/973,253, filed on Sep. 18, 2007.

(51) Int. Cl. G06F 17/50; G06F 7/20; G06F 17/30

(52) U.S. Cl. 703/1; 707/5; 707/E17.014

(57) ABSTRACT

The present invention relates to systems and methods for representing target protein binding sites and for docking fragment molecules and structurally modified fragment molecules to target protein binding sites. The systems and methods are useful for designing active molecules in drug discovery. Methods of this invention can be implemented in a computer system and may be embodied as computer code in a computer readable medium.

### STATEMENT OF RELATED APPLICATIONS

This patent application claims the benefit of U.S. Provisional Patent Application No. 60/939,967, filed May 24, 2007, and U.S. Provisional Patent Application No. 60/973,253, filed Sep. 18, 2007, the contents of which are incorporated by reference in their entireties.

This application is related to U.S. patent application Ser. No. ______, filed on even date herewith, entitled “Systems and Methods for Predicting Ligand-Protein Binding Interactions,” and U.S. patent application Ser. No. ______, filed on even date herewith, entitled “Systems and Methods for Designing Molecules with Affinity for Therapeutic Target Proteins,” the contents of which are incorporated by reference in their entireties.

### FIELD OF THE INVENTION

The present invention relates to systems and methods for representing target protein binding sites and for docking fragment molecules and structurally modified fragment molecules to target protein binding sites. The systems and methods are useful for designing active molecules in drug discovery.

### BACKGROUND OF THE INVENTION

Prediction of the geometry of protein-ligand complexes and the energy of their interactions is a problem of vital importance in the computer-assisted drug discovery field. Protein structures determined by X-ray crystallography and other methods of protein structure elucidation provide detailed information about the three-dimensional disposition of atoms in proteins and reveal the molecular arrangement of protein binding sites, where the proteins form interactions with other molecular entities. The information about the structure of a protein binding site can be utilized in the drug discovery process for molecular design or virtual screening aimed at identifying molecules capable of fitting into the protein binding site by virtue of spatial and stereo-electronic complementarity (Jones et al., J. Mol. Biol. 267, p. 727 (1997)).

Computational methodologies applicable in drug design and virtual screening using protein three-dimensional structures have the potential to improve the efficiency of the drug discovery process. However, significant limitations exist in the reliability of the computerized screening and design methods. The process of virtual screening encompasses two basic problems: (i) docking compounds into a target protein binding site and (ii) scoring of the docked geometries. The docking process involves a prediction of conformation and orientation of a molecule or a molecular fragment within the target protein binding site. Scoring of these predicted conformations and orientations involves quantitative assessment of binding affinities of the docked ligands for their protein targets, with the aim of prioritizing molecules having higher relative probability of binding to a protein. Both docking and scoring computational methods suffer from limited understanding of the molecular features and forces responsible for the specificity of biological recognition, and from the complexity associated with the dynamics of molecular interactions.

The form of representation of a protein receptor plays an important role in the docking and scoring methods. The representations provide information on residues located at the interface of the protein complex with other molecules. There are three basic forms of representation of a protein receptor: atomic, surface, and grid (Halperin et al., Proteins 47, p. 409 (2002)). Atomic representations can be used in connection with the potential energy function, evaluating pairwise atomic interactions (Burnett et al., Proteins 41, p. 173 (2000)). Some newer methods based on the atomic representation utilize atom quadruplet potentials derived from Delaunay tessellation of protein structures, which define sets of four nearest-neighboring amino acid quadruplets (Krishnamoorthy and Tropsha, Bioinformatics 19, p. 1540 (2003)). Methods using the surface-based protein receptor representations attempt to align points on surfaces by minimizing the angle between the surfaces of opposing molecules (Norel et al., Biopolymers 34, p. 933 (1994); Norel et al., Proteins 35, p. 403 (1999); Connolly, J. Appl. Cryst. 16, p. 548 (1983); Connolly, Science 221, p. 709 (1983)). Grid representations are based on the storage of information about the receptor energy contributions, or any property quantifying the likelihood of favorable interaction with other molecules, on grid points situated at discrete locations within a protein binding site. The grid points can carry information about electrostatic or van der Waals potential energy derived from the distance and nature of protein atoms in the proximity of each grid point. The advantage of grid representation methods lies in the reduction of computational times in docking procedures where energy contributions for individual atoms in a molecule are read from stored values at the nearest grid point (Goodford, J. Med. Chem. 28, p. 849 (1985)).

Scoring methods are employed to assess the strength of interactions in the protein-ligand complexes generated by docking procedures quantitatively, in order to estimate the relative likelihood of a ligand to bind a protein target. Design of reliable scoring functions is of fundamental importance for advancement in the application of rational drug design in the drug discovery research. Free energy calculations are computationally too expensive to be used for evaluation of large numbers of protein-ligand complexes (Kollman, Chem. Rev. 93, p. 2395 (1993); Simonson et al., Acc. Chem. Res. 35, p. 430 (2002)). Currently used scoring methods implemented in docking programs make multiple approximations and simplifications of physical phenomena that determine molecular recognition. There are three classes of scoring methods, implementing either force-field-based, empirical, or knowledge-based algorithms.

Force-field-based scoring methods, developed on the concept of molecular mechanics, quantify energy associated with a protein-ligand complex as a sum of two energies: the receptor-ligand interaction energy and the internal ligand energy. Various force-field scoring functions differ in parameters employed in the molecular mechanics algorithms used; however, the functional forms can be similar. For example, G-Score (Kramer et al., Proteins 37, p. 228 (1999)) is based on the Tripos force-field and AutoDock (Morris et al., J. Comput. Chem. 19, p. 1636 (1998)) on the AMBER force-field (Weiner et al., J. Comput. Chem. 7, p. 252 (1986)). The protein-ligand interactions can be assessed by the force-field methods using van der Waals and electrostatic terms. The van der Waals energy term is computed using the Lennard-Jones potential function with varying parameters. The electrostatic term is represented by the Coulombic formulation with distance-dependent dielectric function. Force-field methods have major limitations originating from exclusion of salvation and entropic terms, and from the binding energy approximations used to compute the enthalpic gas-phase contributions to structure and binding energy. Furthermore, because of cut-off distance for computation of non-bonded interactions, they do not provide accurate estimates of long-range interactions. Some newer applications implementing the force-field methods attempt to address these limitations. For example, explicit protein-ligand hydrogen bonding terms are included in Gold (Verdonk et al., Proteins 52, p. 609 (2003)) and AutoDock (Morris et al., J. Comput. Chem. 19, p. 1636 (1998)) programs. Other popular force-field methods include D-Score (Kramer et al., Proteins 37, p. 228 (1999)) and DOCK (Ewing et al., J. Comput. Aided Mol. Des. 15, p. 411 (2001)).

Empirical scoring functions can be represented by several parameterized functions, fitted to reproduce experimental data such as binding energies and conformations (Bohm, J. Comp. Aided Mol. Des. 6, p. 593 (1992)). Empirical scoring functions approximate binding energies based on the sum of individual uncorrelated terms with coefficients obtained from regression analysis using experimentally determined binding energies. The functional terms are simplified counterparts of those used by the force-field functions. Disadvantages of empirical scoring functions stem from their dependence on empirical datasets used to perform regression analysis and fitting. Consequently, they lack general applicability, since terms from differently fitted functions are difficult to recombine into new scoring functions. More popular programs based on the empirical scoring functions include LUDI (Bohm, J. Comput. Aided Mol. Des. 8, p. 243 (1994)), ChemScore (Eldridge et al., J. Comput. Aided Mol. Des. 11, p. 425 (1996)), F-Score (Rarey et al., J. Mol. Biol. 261, p. 470 (1997)), SCORE (Wang et al., J. Mol. Model. 4, p. 379 (1998); Tao and Lai, J. Comput. Aided Mol. Des. 15, p. 429 (2001)), Fresno (Rognan et al., J. Med. Chem. 42, p. 4650 (1999)), and X-SCORE (Wang et al., J. Comput. Aided Mol. Des. 16, p. 11 (2002)).

Knowledge-based scoring functions are designed to reproduce experimental structures rather than binding energies. In these functions, protein-ligand complexes are modeled based on relatively simple atomic interaction-pair potentials. Number and type of interactions for each atom depend on their molecular environment. These functions attempt to capture binding effects implicitly, without explicit quantification of the underlying forces driving molecular interactions. Some established knowledge-based scoring functions include Potential of Mean Force (PMF) (Muegge, Perspect. Drug Discov. Des. 20, p. 99 (2000); Muegge, J. Comput. Chem. 22, p. 418 (2001); Muegge and Martin, J. Med. Chem. 42, p. 791 (1999)), DrugScore (Gohlke et al., J. Mol. Biol. 295, p. 337 (2000)), and SMoG (DeWitte and Shakhnovich, J. Am. Chem. Soc. 118, p. 11733 (1996)). PMF and DrugScore include solvent-accessibility corrections to pairwise potentials. In an attempt to improve performance of the knowledge-based scoring functions, higher order potentials were implemented. Four-body contacts based on quadruplets of nearest amino acids were utilized in scoring of protein-ligand interactions with some success (Krishnamoorthy and Tropsha Bioinformatics 19, p. 1540 (2003)). Although computationally relatively simple, the disadvantage of knowledge-based scoring functions is that their parameters are derived from a limited number of protein-ligand complexes.

Recently attempts have been made to combine biochemical and biophysical data with protein docking methods. These data can transform information from mutagenesis assays, mass spectrometry (MS), nuclear magnetic resonance (NMR), small-angle X-ray scattering, or electron microscopy and tomography into information on residues located at the interface of a protein complex (Aalt et al., FEBS J. 272, p. 293, (2005)).

There is a need in the art for faster, less computationally demanding, and more accurate prediction of molecular affinities of drug candidates toward protein therapeutic targets, as compared to the prior art methods. Application of such methods could dramatically improve the efficiency of the drug discovery process and could help to reduce the cost of pharmaceutical research and discovery.

### SUMMARY OF THE INVENTION

The present invention relates to systems and methods for representing target protein binding sites and for docking fragment molecules and structurally modified fragment molecules to target protein binding sites. The systems and methods are useful for designing active molecules in drug discovery.

According to one aspect, the invention relates to a three-dimensional data mining procedure that extracts implicit information about energies associated with spatial positioning of atoms in the vicinity of amino acid residues in a protein receptor. In one embodiment, the procedure estimates the strength of interaction between a target protein and a candidate molecule by transformation of the three-dimensional protein structural data into an energy surrogate function. The information contained in datasets collected from thousands of solvent protein structures implicitly represents knowledge about the interplay of multiple long-range and short-range forces acting at interfaces of non-covalently bound molecular residues that are difficult to express in the prior art computational methods.

In another aspect of the invention, drug candidates are identified from a set of molecular structures representing chemical series with a degree of structural diversity, including multiple pharmacophores or a single pharmacophore with varying substituent parts, by a method comprising the following steps for each molecule in the evaluated set: (i) conformational sampling, (ii) determination of an optimal binding position on a protein receptor surface based on computation of overlap between atoms in a candidate molecule and the distribution density factors computed for a protein receptor, and (iii) comparison of the computed maximum overlap with a benchmark value determined for the protein target based on affinities of known complexes.

In some embodiments, the methods are based on estimates of the strength of interaction between a target protein described herein and a candidate molecule by transformation of the three-dimensional protein structural data into an energy surrogate function. In one embodiment, the information contained in the datasets collected from thousands of solvent protein structures implicitly represents knowledge about the interplay of multiple long-range and short-range forces acting at interfaces of non-covalently bound molecular residues that are difficult to express in the prior art computational methods. The methods of the present invention are advantageous over not only the knowledge-based scoring functions, but also the empirical and force-field functions employed in the known docking and scoring methods. In addition, the methods and systems described herein can compete in precision with results of computationally demanding free energy calculations. The methods of the present invention can deliver better results faster than conventional methods and, therefore, are useful in the drug discovery process.

In one aspect, the invention provides a method for determining a candidate molecule's ability to bind a target protein, comprising calculating a score for the candidate molecule, wherein the score is a function of a position of the candidate molecule relative to a field of distribution densities on a three-dimensional target protein structure.

In one embodiment, the score is calculated according to the following equation:

$$Score = {\sum }_{i = 1}^{n} C * \frac{{Q}_{i}}{Q}$$

wherein Qᵢ is a distribution density factor or any other measure of occurrence frequency of the atom type at its location or at the location of the nearest grid point in the binding site; Q is the optimal distribution density factor or any other measure of occurrence frequency for the atom type; C is the proportionality constant for the atom type; and n is the number of atoms in the candidate molecule.

In another embodiment, the method further comprises the step of comparing the score of the candidate molecule to a score threshold value.

In another aspect, the invention provides a method for obtaining structural data representing a target protein binding site, comprising the steps of a) determining type and conformation of a plurality of amino acids of a ligand binding site on a three-dimensional target protein structure; b) searching a structure database for amino acids matching the type and conformation of an amino acid of the binding site; c) extracting three-dimensional coordinates of the atoms of a matched amino acid and atoms surrounding the matched amino acid into a coordinate set; d) moving the coordinate set with respect to the searched amino acid until the matched amino acid is aligned with the searched amino acid; e) assigning types and descriptors to the atoms of matched amino acids and atoms surrounding those matched amino acids, wherein the descriptors indicate that those atoms correlate with the searched amino acid; and f) producing a binding site data set, wherein each data point of the set comprises coordinates and type of an atom surrounding a matched amino acid, wherein the binding site data set is used for determining a candidate molecule's ability to bind a target protein.

In one embodiment, the method further comprises the step of repeating steps b) to d) for another amino acid of the binding site.

In another embodiment, the method further comprises the step of deleting from the binding site data set each data point of a given type that is geometrically closer to an amino acid with which it does not correlate than that amino acid's data point of the same type.

In another embodiment, each data point is weighted according to the following equation:

$${w}_{i ( j )} = 1 - \frac{{n}_{j}}{N}$$

wherein wᵢ₍ⱼ₎ is the weight of i^{th} data point correlating with searched amino acid j; nⱼ is total number of matched amino acids identified for the searched amino acid j; and N is the final number of data points in the set.

In another embodiment, each data point is weighted according to the following equation:

$${w}_{i ( j )} = \frac{{n}_{max}}{{n}_{j}}$$

wherein wᵢ₍ⱼ₎ is the weight of i^{th} data point correlating with searched amino acid j; nⱼ is total number of matched amino acids identified for the searched amino acid j; and nₘₐₓ is the maximum number of matched amino acids.

In one embodiment, the method for obtaining structural data representing a target protein binding site further comprises the steps of a) superimposing a grid comprising a plurality of grid points and the binding site data set; b) selecting all data points within a selected distance from a given grid point; c) assigning a weight to each selected data point according to its distance from the given grid point; and d) calculating an occurrence frequency for each atom type at each given grid point.

In another embodiment, the weight of a data point is calculated according the following equation:

wᵢ′=wᵢ*f(dᵢ)

wherein wᵢ′ is the data point's new weight; wᵢ is the data point's initial weight; and f(dᵢ) is the function that relates the weight of i^{th} data point to its distance from a corresponding probe position.

In another embodiment, f(dᵢ) is selected from the group consisting of a triangular, a bell, a trapezoidal, a harvesine, and an exponential function.

In another embodiment, the exponential function is a Gaussian function.

In another embodiment, the occurrence frequency for each atom type at each given grid point is calculated according to the following equation:

$${f}_{j} = {\sum }_{i = 1}^{n} {w}_{i}^{′}$$

wherein wᵢ′ is the adjusted weight of a data point; and n is the number of occurrences of an atom type in a grid point's effective radius.

In another embodiment, the spacing between grid points is 0.1-0.3 Å.

In another embodiment, the method further comprises the step of calculating distribution densities at each given grid point.

In another embodiment, each distribution density is calculated according the following equation:

$${Q}_{j} = ln \frac{{f}_{j}}{{p}_{j}}$$

wherein Qⱼ is the distribution density factor of the j^{th} given grid point calculated separately for each atom type; fⱼ is the observed occurrence frequency for each atom type; and pⱼ is the expected occurrence frequency for each atom type at a grid point location j, calculated according to the equation:

$${p}_{j} = p * \frac{{\sum }_{j = 1}^{m} {\sum }_{l} {f}_{jl}}{m}$$

wherein p is the relative probability of occurrence for each atom type calculated based on statistical analysis of a sample of protein structures; fⱼₗ is the combined weight-adjusted frequency for all atom types I at the j^{th} given grid point; and m is the number of given grid points.

In another aspect, the invention provides a method for determining a candidate molecule's ability to bind a target protein, comprising optimizing a score according to a position of the candidate molecule relative to a field of distribution densities of the target protein structure.

In one embodiment, the method further comprises the step of comparing the optimized score to a score threshold value.

In another embodiment, the step of optimizing the score comprises the steps of a) obtaining three-dimensional coordinates for each atom in the candidate molecule; b) determining a set of translational and rotational geometric parameters for an initial placement of the candidate molecule in the target protein binding site structure; c) determining a new set of translational and rotational geometric parameters site, wherein the new set of translational and rotational geometric parameters is determined by maximizing the overlap between atom positions of the candidate molecule and the field of distribution densities; and d) evaluating the candidate molecule-target protein complex geometry.

In another embodiment, the method further comprises the step of repeating steps b) and c) until the overlap between atom positions of the candidate molecule and the field of distribution densities is maximized.

In another embodiment, the step of determining a set of translational and rotational geometric parameters for an initial placement of the candidate molecule in the target protein binding site structure is accomplished with a set of randomly selected translational and rotational parameters.

In another embodiment, the step of determining a set of translational and rotational geometric parameters for an initial placement of the candidate molecule in the target protein binding site structure is accomplished with a set of specifically selected translational and rotational parameters.

Yet another aspect of this invention relates to an optimization procedure that iteratively positions the candidate molecule on a target protein surface, to identify a local or global energy minimum for the complex, which represents the maximum possible overlap between atoms in the candidate molecule and distribution density factors computed for the target protein.

In one embodiment of this aspect, the affinity of a molecule for a protein receptor is evaluated based on optimization of a scoring function between a protein receptor target and a candidate molecule (ligand), including iterative positioning of the ligand molecule on the protein surface and recalculation of a scoring function associated with the new position of the ligand, with the aim of identifying a local or global energy minimum for the complex between the candidate molecule and protein receptor, which represents the maximum possible overlap between atoms in a candidate molecule and the distribution density factors computed for a protein receptor. Affinity of the candidate molecule for the target protein can be estimated based on a comparison of a computed score or density distribution coverage maximum for the candidate molecule with a benchmark value obtained for a molecule of empirically-determined affinity.

In another aspect, the invention relates to a method for designing a molecule with affinity for a target protein, comprising evaluating a position of a fragment molecule relative to a field of distribution densities on a three-dimensional target protein structure.

In one embodiment of this aspect, the method comprises the steps of a) obtaining three-dimensional coordinates for each atom in the fragment molecule; b) determining a set of translational and rotational geometric parameters for an initial placement of the fragment molecule in the target protein binding site structure; c) determining a new set of translational and rotational geometric parameters, wherein the new set of translational and rotational geometric parameters is determined by maximizing the overlap between atom positions of the fragment molecule and the field of distribution densities; d) evaluating the fragment molecule-target protein complex geometry; e) modifying the fragment; f) determining a set of translational and rotational geometric parameters for an initial placement of the modified fragment molecule in the target protein binding site structure; and g) repeating steps c) and d).

In another embodiment, the step of determining a set of translational and rotational geometric parameters for an initial placement of the candidate molecule in the target protein binding site structure is accomplished with a set of randomly selected translational and rotational parameters.

In another embodiment of this aspect, the step of determining a set of translational and rotational geometric parameters for an initial placement of the candidate molecule in the target protein binding site structure is accomplished with a set of specifically selected translational and rotational parameters.

In another embodiment, the step of determining a set of translational and rotational geometric parameters for an initial placement of the candidate molecule in the target protein binding site structure comprises the steps of a) selecting n atoms in the candidate molecule; b) selecting n specific locations in the target protein binding site; and c) aligning the atoms in the candidate molecule with the corresponding locations in the target protein binding site by rotational and translational movement to minimize the following equation:

$$I ( T , R ) = {\sum }_{j = 1}^{n} \vert Mj - Aj \vert$$

wherein T is a translation vector; R is a rotation 3×3 matrix; n is the number of selected atoms in the candidate molecule; Mj is a vector defining a position of the distribution density maximum j; and Aj is a vector defining the position of the corresponding atom j in the candidate molecule.

In another embodiment, the step of determining a set of translational and rotational geometric parameters for an initial placement of the modified fragment molecule in the target protein binding site structure comprises the steps of: a) selecting n atoms in the modified fragment molecule; b) selecting n specific locations in the target protein binding site; and c) aligning the atoms in the modified fragment molecule with the corresponding locations in the target protein binding site by rotational and translational movement to minimize the following equation:

$$I ( T , R ) = {\sum }_{j = 1}^{n} \vert Aj - {Aj}^{′} \vert$$

wherein T is a translation vector; R is a rotation 3×3 matrix; n is number of corresponding atoms in the original and modified fragment considered during the placement of the modified fragment; Aj is a vector defining a position of the atom j in the original fragment; and Aj′ is a vector defining the position of the corresponding atom j in the modified fragment.

In another embodiment, the step of determining the new set of translational and rotational geometric parameters comprises the steps of a) determining distribution density factors Qᵢ for locations of atoms i in docked molecule; and b) calculating a position of the candidate molecule in the target protein binding site I(T,R,B).

In another embodiment, the position of the candidate molecule in the target protein binding site is calculated according to the following equation:

$$I ( T , R , B ) = {\sum }_{i = 1}^{n} {CQ}_{i}$$

wherein n is the number of atoms in the candidate molecule; Qᵢ is the distribution density factor at location of the i^{th} atom in a candidate molecule; I(T,R,B) represents the position of the candidate molecule in the binding site given by translational (T), rotational (R), and rotatable bond parameters (B); and C is the proportionality constant for the atom type.

In another embodiment, the position of the candidate molecule in the target protein binding site is calculated according to the following equation:

$$I ( T , R , B ) = {\sum }_{i = 1}^{n} {CQ}_{i} {F}_{i}$$

wherein n is the number of atoms in the candidate molecule; Qᵢ is the distribution density factor at location of the i^{th} atom in a candidate molecule; I(T,R,B) represents the position of the candidate molecule in the binding site given by translational (T), rotational (R), and rotatable bond parameters (B); C is the proportionality constant for the atom type; and Fᵢ represents the proportion of atom's surface proportion in the contact with the protein surface.

In another embodiment, the position of the candidate molecule in the target protein binding site is calculated according to the following equation:

$$I ( T , R , B ) = {\sum }_{i = 1}^{n} {CD}_{i}$$

wherein n is the number of atoms in the candidate molecule; Dᵢ is the distance between i^{th} atom in the candidate molecule and a respective local distribution density maximum; I(T,R,B) represents the position of a ligand in a binding site given by translational (T), rotational (R), and rotatable bond parameters (B); and C is the proportionality constant for the atom type.

In another embodiment, the position of the candidate molecule in the target protein binding site is calculated according to the following equation:

$$I ( T , R , B ) = {\sum }_{i = 1}^{n} {CD}_{i} {F}_{i}$$

wherein n is the number of atoms in the candidate molecule; Dᵢ is the distance between i^{th} atom in the candidate molecule and a respective local distribution density maximum; I(T,R,B) represents the position of a ligand in a binding site given by translational (T), rotational (R), and rotatable bond parameters (B); C is the proportionality constant for the atom type; and Fᵢ represents the proportion of atom's surface proportion in the contact with the protein surface.

In another embodiment, the step of evaluating the candidate molecule-target protein complex geometry comprises calculating a score according to the following equation:

$$Score = {\sum }_{i = 1}^{n} C * \frac{{Q}_{i}}{Q}$$

wherein Qᵢ is a distribution density factor or any other measure of occurrence frequency of the atom type at its location or at the location of the nearest grid point in the binding site; Q is the optimal distribution density factor or any other measure of occurrence frequency for the atom type; C is the proportionality constant for the atom type; and n is the number of atoms in the candidate molecule.

In another embodiment, the method further comprises the step of comparing the score to a score threshold value.

In another embodiment, the step of evaluating the fragment molecule-target protein complex geometry comprises calculating a distribution density maxima coverage according to the position of the fragment molecule relative to a field of distribution densities of the target protein structure, according to the following equations:

$${DDMC}_{Total} = \frac{{CM}_{Total}}{{TM}_{Total}} \times 100$$

$${DDMC}_{HD} = \frac{{CM}_{HD}}{{TM}_{HD}} \times 100$$

$${DDMC}_{HA} = \frac{{CM}_{HA}}{{TM}_{HA}} \times 100$$

$${DDMC}_{AP} = \frac{{CM}_{AP}}{{TM}_{AP}} \times 100$$

wherein DDMC_{Total}, DDMC_{HD}, DDMC_{HA}, and DDMC_{AP} are total distribution density maxima coverage for all, hydrogen bond donor, hydrogen bond acceptor, and apolar maxima, respectively; CM_{HD}, CM_{HA}, and CM_{AP} are number of covered distribution density maxima for hydrogen bond donor, hydrogen bond acceptor, and a polar types, respectively; and TM_{HD}, TM_{HA}, and TM_{AP} are total number of considered distribution density maxima for hydrogen bond donor, hydrogen bond acceptor, and apolar types, respectively.

In another embodiment, the step of evaluating the fragment molecule-target protein complex geometry comprises calculating a relative distribution density maxima coverage according to the position of the fragment molecule relative to a field of distribution densities of the target protein structure, according to the following equations:

$${DDMC}_{Total}^{′} = \frac{{DDMC}_{Total ( Fragment )}}{{DDMC}_{Total ( NativeLigand )}} \times 100$$

$${DDMC}_{HD}^{′} = \frac{{DDMC}_{HD ( Fragment )}}{{DDMC}_{HD ( NativeLigand )}} \times 100$$

$${DDMC}_{HA}^{′} = \frac{{DDMC}_{HA ( Fragment )}}{{DDMC}_{HA ( NativeLigand )}} \times 100$$

$${DDMC}_{AP}^{′} = \frac{{DDMC}_{AP ( Fragment )}}{{DDMC}_{AP ( NativeLigand )}} \times 100$$

wherein DDMC′_{Total}, DDMC′_{HD}, DDMC′_{HA}, and DDMC′_{AP} represent fragment's relative distribution density maxima coverage for all, hydrogen bond donor, hydrogen bond acceptor, and apolar maxima, respectively.

In another embodiment, the method further comprises the step of comparing the distribution density maxima coverage to a distribution density maxima coverage threshold value.

In another embodiment, the method further comprises the step of comparing the relative distribution density maxima coverage to a relative distribution density maxima coverage threshold value.

In another embodiment, the target protein is selected from the group consisting of Raf kinase, Rho kinase, NF-κB, VEGF receptor kinase, JAK-3, CDK2, FLT-3, EGFR kinase, PKA, p21-activated kinase, MAPK, JNK, AMPK, phosphodiesterase PDE4, Abl kinase, phosphodiesterase PDE5, ADAM33, HIV-1 protease, HIV integrase, RSV integrase, XIAP, thrombin, tissue type plasminogen activator, matrix metalloproteinase, beta secretase, src kinase, fyn kinase, lyn kinase, ZAP-70 kinase, ERK-1, p38 MAPK, CDK4, CDK5, GSK-3, KIT kinase, FLT-1, FLT-4 kinase, KDR kinase, and COT kinase, as described in the detailed description.

In some embodiments, the methods further comprise producing a candidate molecule.

In another aspect, the invention provides a system for discovering a molecule with a binding affinity toward a protein target, comprising a processor and a memory in electrical communication with the processor, wherein the processor is configured to carry out any one of the methods described above.

In another aspect, the invention provides a computer readable medium having computer readable program code embodied therein, wherein the computer readable program code causes the computer to carry out any one of the methods described above.

In one embodiment, the invention relates to a computer readable medium having computer readable program code embodied therein, wherein the computer readable program code causes the computer to carry out the method comprising the steps of obtaining three-dimensional coordinates for each atom in the fragment molecule, determining a set of translational and rotational geometric parameters for an initial placement of the fragment molecule in the target protein binding site structure, determining a new set of translational and rotational geometric parameters, wherein the new set of translational and rotational geometric parameters is determined by maximizing an overlap between atom positions of the fragment molecule and the field of distribution densities, evaluating the fragment molecule-target protein complex geometry, modifying the fragment molecule, and determining a set of translational and rotational geometric parameters for an initial placement of the modified fragment molecule in the target protein binding site structure.

This determination comprises the steps of selecting n atoms in the fragment molecule, selecting n specific locations in the target protein binding site, and aligning the atoms in the fragment molecule with the corresponding locations in the target protein binding site by rotational and translational movement to minimize the following equation:

$$I ( T , R ) = {\sum }_{j = 1}^{n} \vert Mj - Aj \vert$$

wherein T is a translation vector; R is a rotation 3×3 matrix; I(T,R) represents the position of the fragment molecule in the binding site given by translational and rotational geometric parameters; n is the number of selected atoms in the fragment molecule; Mj is a vector defining a position of the distribution density maximum j; and Aj is a vector defining the position of the corresponding atom j in the fragment molecule. The steps of determining a new set of translational and rotational geometric parameters and evaluating the fragment molecule-target protein complex geometry are then repeated.

In another aspect, the invention relates to a computer system comprising a processor and a memory in electrical communication with the processor, wherein the memory has stored therein data indicative of a three-dimensional target protein binding site representation, comprising the binding site data set produced according to any of the methods described herein.

In another aspect, the invention relates to a computer program product comprising a computer usable medium having computer readable program code comprising computer instructions to carry out a method described herein. In one embodiment, the invention relates to a computer program product comprising a computer usable medium having computer readable program code comprising computer instructions for determining type and conformation of a plurality of amino acids of a ligand binding site on a three-dimensional target protein structure, searching a structure database for amino acids matching the type and conformation of an amino acid of the binding site, extracting three-dimensional coordinates of the atoms of a matched amino acid and atoms surrounding the matched amino acid into a coordinate set, moving the coordinate set with respect to the searched amino acid until the matched amino acid is aligned with the searched amino acid, and assigning types and descriptors to the atoms of matched amino acids and atoms surrounding those matched amino acids. The descriptors indicate that those atoms correlate with the searched amino acid, and a binding site data set is produced. Each data point of the set comprises coordinates and type of an atom surrounding a matched amino acid. The binding site data set is used for determining a candidate molecule's ability to bind a target protein.

In another embodiment, this invention relates to a computer program product comprising a computer usable medium having computer readable program code comprising computer instructions to a method comprising the steps of obtaining three-dimensional coordinates for each atom in the fragment molecule, determining a set of translational and rotational geometric parameters for an initial placement of the fragment molecule in the target protein binding site structure, determining a new set of translational and rotational geometric parameters, wherein the new set of translational and rotational geometric parameters is determined by maximizing an overlap between atom positions of the fragment molecule and the field of distribution densities, and evaluating the fragment molecule-target protein complex geometry. This evaluation comprises calculating a distribution density maxima coverage according to the position of the fragment molecule relative to a field of distribution densities of the target protein structure, according to the following equations:

$${DDMC}_{Total} = \frac{{CM}_{Total}}{{TM}_{Total}} \times 100$$

$${DDMC}_{HD} = \frac{{CM}_{HD}}{{TM}_{HD}} \times 100$$

$${DDMC}_{HA} = \frac{{CM}_{HA}}{{TM}_{HA}} \times 100$$

$${DDMC}_{AP} = \frac{{CM}_{AP}}{{TM}_{AP}} \times 100$$

where DDMC_{Total}, DDMC_{HD}, DDMC_{HA}, and DDMC_{AP} are total distribution density maxima coverage for all, hydrogen bond donor, hydrogen bond acceptor, and apolar maxima, respectively; CM_{HD}, CM_{HA}, and CM_{AP} are number of covered distribution density maxima for hydrogen bond donor, hydrogen bond acceptor, and apolar types, respectively; and TM_{HD}, TM_{HA}, and TM_{AP} are total number of considered distribution density maxima for hydrogen bond donor, hydrogen bond acceptor, and apolar types, respectively. The method of this embodiment further includes modifying the fragment molecule, and determining a set of translational and rotational geometric parameters for an initial placement of the modified fragment molecule in the target protein binding site structure. The steps of determining a new set of translational and rotational geometric parameters and evaluating the fragment molecule-target protein complex geometry are then repeated.

In another aspect, the invention relates to a method executed by a computer under the control of a program, the computer including a memory for storing the program, and the method comprises any of the ones described herein.

In another aspect, the invention relates to a computer implemented method for modeling a target protein binding site for determining a candidate molecule's ability to binding to the target protein binding site, comprising the steps of any of the methods described herein.

In one embodiment, the invention relates to a computer implemented method for modeling a target protein binding site for determining a candidate molecule's ability to binding to the target protein binding site, comprising the steps of determining type and conformation of a plurality of amino acids of a ligand binding site on a three-dimensional target protein structure, searching a structure database for amino acids matching the type and conformation of an amino acid of the binding site, extracting three-dimensional coordinates of the atoms of a matched amino acid and atoms surrounding the matched amino acid into a coordinate set, moving the coordinate set with respect to the searched amino acid until the matched amino acid is aligned with the searched amino acid, assigning types and descriptors to the atoms of matched amino acids and atoms surrounding those matched amino acids, wherein the descriptors indicate that those atoms correlate with the searched amino acid, producing a binding site data set, wherein each data point of the set comprises coordinates and type of an atom surrounding a matched amino acid, wherein the binding site data set is used for determining a candidate molecule's ability to bind a target protein.

The steps of searching a structure database for amino acids matching the type and conformation of an amino acid of the binding site, extracting three-dimensional coordinates of the atoms of a matched amino acid and atoms surrounding the matched amino acid into a coordinate set and moving the coordinate set with respect to the searched amino acid until the matched amino acid is aligned with the searched amino acid are repeated for another amino acid of the binding site. In one embodiment, the method further includes superimposing a grid comprising a plurality of grid points and the binding site data set, selecting all data points within a selected distance from a given grid point, assigning a weight to each selected data point according to its distance from the given grid point, and calculating an occurrence frequency for each atom type at each given grid point.

### BRIEF DESCRIPTION OF THE DRAWINGS

FIG. 1 is a block diagram of a method for computing the distribution density field stored at grid points superimposed on a protein surface according to one embodiment of the invention;

FIG. 2 is a block diagram of a method for docking molecules into a protein target augmented by the computed field of distribution densities according to one embodiment of the invention;

FIG. 3 is a block diagram of a method for discovering biologically active drug candidates according to one embodiment of the invention; and

FIG. 4 is a block diagram of a method for designing molecules with affinity for a therapeutic protein target, augmented by the computed field of distribution densities according to one embodiment of the invention.

### DETAILED DESCRIPTION OF THE INVENTION

Discovery of a clinical drug candidate requires synthesis and screening of a large number of chemical substances. This approach to the drug discovery requires considerable time and resources. Methods for prediction of biological activity using algorithms implemented in computer storage devices have the potential to streamline drug discovery research. A critical aspect of computer-assisted drug discovery methods is a correct estimate of geometries of protein-ligand complexes and assignment of correct quantitative measures of the strength of molecular interactions represented by these geometries. The currently available methods for the prediction of these properties are either computationally too demanding or they employ in their algorithms approximations that reduce their predictive ability. For these reasons, currently available computer-assisted drug discovery methods have limited applicability in the settings of pharmaceutical drug discovery research.

The knowledge-based docking and scoring methods have the potential to incorporate information about the forces driving molecular interactions that are difficult to account for in the algorithms of empirical and force-field-based computational methods. The major challenge lies in converting the information implicit in the structural or other scientific data into an energy surrogate function applicable to prediction of the strength of molecular interactions. The prior art knowledge-based methods limit their algorithm to measurement of average, one-dimensional inter-atomic distances between specific atom types in the known protein-ligand complexes and derive energy potential functions from these distances. However, the information implicit in the protein structural data is considerably richer and provides insight about interplay of multiple long-range and short-range forces acting on the interfaces of molecular complexes. The methods of the present invention allow extraction of this valuable information from protein structural data and its conversion into a scoring function that acts as energy surrogate function and affords a precise estimate of the strength of protein-ligand interactions. Estimation of the strength of protein-ligand interactions forms a basis for the prediction of drug candidates' affinities toward therapeutic targets, and potentially their biological activity.

The methods presented in this invention provide the access to the wealth of information inherent in the thousands of protein three-dimensional structures deposited in the Protein Data Bank (PDB) or other protein structure databases. Through geometric intersection of thousands of collected datasets rendered on the protein-receptor surface and a discretization procedure using membership functions that allocate individual weights of collected data at discrete locations in a protein-binding site, the methods of the invention create a scoring and docking methodology based on distribution density factors that afford superior prediction of geometries of protein-ligand complexes and associated quantitative measures of the strength of their interactions. The methods used to estimate the strength of interaction between proteins and ligands presented in this invention differ substantially from docking and scoring methods of the prior art, and provide considerable improvement in terms of precision of estimated affinities and geometries of the protein-ligand complexes. In addition, in contrast to other methods, the achieved precision of the methods described herein does not increase the computational burden and therefore the methods of this invention afford higher computational speed in terms of computational time demanded adjusted for precision. These performance features increase the reliability of the obtained ‘in silico’ screening results by reducing the number of false positive and false negative results and enhance the suitability of the methods for use in the settings of the drug discovery research.

Computation of distribution densities stored on grid points superimposed on a protein surface is compatible with many docking methods known in the art utilizing variables such as semi-empirical or potential energies that are pre-computed and stored on grid points. The known docking methods include methods for positioning of a molecule within a protein binding site respective of some score computed in each transient position generated during transitional and rotational movement of a molecule in the binding site and computation of a score applied to estimation favorability of a given position. Utilization of the scoring functions based on distribution density maxima in these docking methods has the potential to enhance their performance in terms of precision and speed.

Discovery of molecules that bind protein targets using the methods of this invention is based on docking of molecules into a field of distribution densities superimposed on a protein surface obtained by a statistical analysis of a large number of three-dimensional protein structures. The docking of molecules is based on optimization of placement of the molecules on a protein target such that a maximum score is achieved.

Three-dimensional structures have been solved for many therapeutic targets for intervention in pathological processes of number of diseases. These structures are available to the public through the PDB or other structural databases or are used internally in academic and industrial institutions. The methods of the present invention are designed to utilize the three-dimensional information about the therapeutic targets to effectively design new chemical substances or screen “in silico” libraries of existing compounds to identify new drug candidates.

Three-dimensional structures of useful therapeutic targets (i.e., target proteins) available in the databases include, but are not limited to: Raf kinase (a target for the treatment of melanoma), Rho kinase (a target in the prevention of pathogenesis of cardiovascular disease), nuclear factor kappaB (NF-κB, a target for the treatment of multiple myeloma), vascular endothelial growth factor (VEGF) receptor kinase (a target for action of anti-angiogenetic drugs), Janus kinase 3 (JAK-3, a target for the treatment of rheumatoid arthritis), cyclin dependent kinase (CDK) 2 (CDK2, a target for prevention of stroke), FMS-like tyrosine kinase (FLT) 3 (FLT-3; a target for the treatment of acute myelogenous leukemia (AML)), epidermal growth factor receptor (EGFR) kinase (a target for the treatment of cancer), protein kinase A (PKA, a therapeutic target in the prevention of cardiovascular disease), p21-activated kinase (a target for the treatment of breast cancer), mitogen-activated protein kinase (MAPK, a target for the treatment of cancer and arthritis), c-Jun NH₂-terminal kinase (JNK, a target for treatment of diabetes), AMP-activated kinase (AMPK, a target for prevention and treatment of insulin resistance), lck kinase (a target for immuno-suppression), phosphodiesterase PDE4 (a target in treatment of inflammatory diseases such as rheumatoid arthritis and asthma), Abl kinase (a target in treatment of chronic myeloid leukemia (CML)), phosphodiesterase PDE5 (a target in treatment of erectile dysfunction), a disintegrin and metalloproteinase 33 (ADAM33, a target for the treatment of asthma), human immunodeficiency virus (HIV)-1 protease and HIV integrase (targets for the treatment of HIV infection), respiratory syncytial virus (RSV) integrase (a target for the treatment of infection with RSV), X-linked inhibitor of apoptosis (XIAP, a target for the treatment of neurodegenerative disease and ischemic injury), thrombin (a therapeutic target in the treatment and prevention of thromboembolic disorders), tissue type plasminogen activator (a target in prevention of neuronal death after injury of central nervous system), matrix metalloproteinases (targets of anti-cancer agents preventing angiogenesis), beta secretase (a target for the treatment of Alzheimer's disease), src kinase (a target for the treatment of cancer), fyn kinase, lyn kinase, zeta-chain associated protein 70 (ZAP-70) protein tyrosine kinase, extracellular signal-regulated kinase 1 (ERK-1), p38 MAPK, CDK4, CDK5, glycogen synthase kinase 3 (GSK-3), KIT tyrosine kinase, FLT-1, FLT-4, kinase insert domain-containing receptor (KDR) kinase, and cancer osaka thyroid (COT) kinase.

### DEFINITIONS

As used herein, a “candidate molecule” refers to any molecule or molecular fragment with known atomic composition and for which three-dimensional coordinates can be computed or obtained by experimental methods such as X-ray crystallography.

Examples of candidate molecules include, but are not limited to, organic molecules, inorganic molecules, or a mixture thereof. Organic molecules include, but are not limited to, small molecules, peptides, proteins, protein nucleic acids, and a combination thereof.

As used herein, a “target protein” or “protein target” (as these terms may be used interchangeably) refers to any naturally occurring peptide, protein, subunit or domain thereof, or protein complex of which a three-dimensional structure expressed in three-dimensional spatial coordinates of all or a representative sample of individual atoms is available through experimental methods including, but not limited to, X-ray crystallography, NMR spectroscopy, or computational methods such as homology modeling. Target proteins also include, without limitation, peptides or proteins known or believed to be involved in the etiology of a given disease, condition or physiological state, or in the regulation of physiological function. The target protein may also be a marker of a biological pathway or a group of cellular structures with identical or similar biological functions. Target proteins may be derived from any living organism, such as a virus, a microorganism (including bacteria, fungi, algae, and protozoa), an invertebrate (including insects and worms), or the normal or cancerous cells of a vertebrate, particularly a mammal (such as apes, monkeys, horses, cows, pigs, goats, llamas, rats, mice, sheep, guinea pigs, cats and dogs) and even more particularly a human. For use in the present invention, it is not necessary for the protein's biochemical function to be specifically identified. Target proteins include without limitation receptors, enzymes, hormones, oncogene products, tumor suppressor genes, viral proteins, and transcription factors, either in purified form or as part of a mixture of proteins and other compounds. Furthermore, target proteins may comprise wild type proteins, or alternatively, mutant or variant proteins, including those with altered stability, activity, or other variant properties, or hybrid proteins to which foreign amino acid sequences, e.g., sequences that facilitate purification, have been added. The target protein may be, inter alia, a glycol-, lipo-, phospho- or metalloprotein. It may also be a nuclear, ribosomal, endoplasmic reticulum, cytoplasmic, membrane, or secreted protein.

As used herein, “field of distribution densities” refers to any set of variables expressing relative occurrence frequency for a specific atom type at discrete locations in a binding site. The set of variables can be computed through discretization of geometrically intersected data collected through statistical analysis of protein structures and superimposed on a region of protein capable of binding a molecule. One non-limiting example of a distribution density variable is a distribution density factor computed as a logarithm of a ratio between computed discrete frequency of specific atom type occurrence and average, expected or random occurrence used as a reference value.

As used herein, “atom type” refers to atom type defined by the atomic number such as carbon, nitrogen, and oxygen, or any other kind of classification including, but not limited to, hydrogen bond donor, hydrogen bond acceptor, apolar atom, neutral atom, charged atom or any other description.

As used herein, a “score” refers to a function of the position of a molecule relative to the field of distribution densities superimposed on a protein target. The score computation can include a function that is a sum of ratios of actual distribution densities and optimal distribution densities computed for individual atoms in a molecule.

As used herein, a “protein binding site” refers to a region of a protein capable of forming a non-covalent or a covalent interaction with a ligand molecule. Residues that are in contact with the ligand molecule are those with at least one atom having a distance from a ligand molecule of 5 Å or less.

As used herein, a “residue” refers to an amino acid.

As used herein, a mathematical “formula” is equivalent to a mathematical equation.

As used herein, a “data point” refers to a spatial point at discrete position in the target protein binding site. A data point includes data such as three dimensional coordinates, type, weight, and a number of the searched amino acid residue to which it correlates. Data points are distinct from grid points, which are formed through the discretization procedure, and distribution density maxima.

As used herein, “given grid point” is meant to be synonymous with “probe position”.

As used herein, “score threshold value” refers to any value to which a score is compared.

As used herein, “geometrically” means “spatially”.

### Computing Distribution Densities

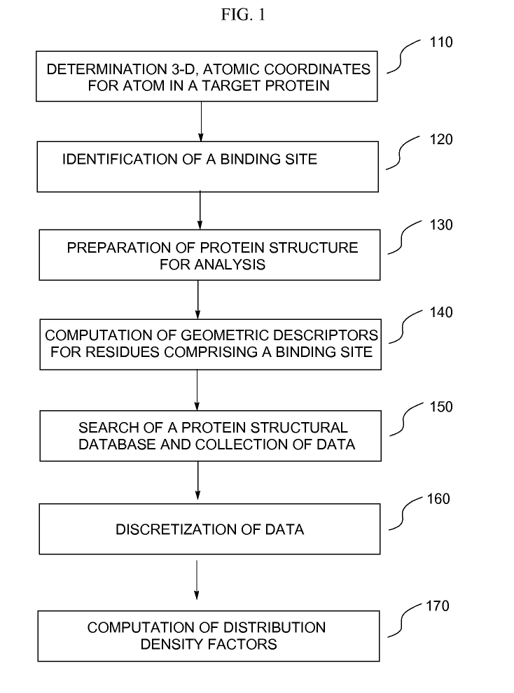

The procedure of computing distribution densities that is useful in subsequent docking of molecules into a protein target is shown in FIG. 1, and comprises steps of: (1) obtaining three-dimensional, atomic coordinates of all or representative atoms in a target protein, (2) identifying a protein binding site, (3) preparing the protein structure for subsequent analysis, (4) determining geometric descriptors of amino acid residues on the molecule-protein interface, (5) searching protein structural database(s), collecting data, and generating a geometric intersection of multiple datasets on a protein surface, (6) discretizing the data using membership functions determining data participation, and associating data with specific weights, (7) calculating distribution density factors proportional to energy for specific atom types and storing on specific grid points, and (8) computing distribution density maxima.

### (1) Obtaining Three-Dimensional Coordinates of the Target Protein

The first step in the computation of distribution densities involves obtaining three-dimensional atomic coordinates of representative atoms of the target protein(s). The coordinates are necessary for atoms in amino acid residues likely to come into contact with the bound molecule. The atomic coordinates of a target protein can be obtained by any means known in the art, including X-ray crystallography, NMR spectrometry, computational modeling or from structure databases such as the PDB. The atomic coordinates can be expressed in a three-dimensional coordinate system. In addition to amino acid residues, the coordinates of a protein target can also contain coenzymes, cofactors, metal ions, solvent molecules (e.g., water molecules), glycosyl moieties, or any other small molecules. In general, the positions of hydrogen atoms in the target protein cannot be determined by experimental methods such as X-ray crystallography and are therefore unavailable from protein structure databases such as the PDB. Various computational tools are known that generate the atomic coordinates for the missing hydrogen atoms (e.g., CNS, Brunger et al., Acta Crystallogr, D. Biol Crystallogr 54, p. 905 (1998)). However, the methods of this invention do not require knowledge of the three-dimensional coordinates of the hydrogen atoms.

### (2) Identifying a Binding Site on the Target Protein

The second step involves identifying the target protein binding site. The binding site on a target protein can be identified by locating a region of the target protein that binds a known ligand based on an available protein-ligand complex structure determined by X-ray crystallography or another experimental method. The molecule binding site can be also determined using known computational methods, such as those described by Bhinge et al., Structure 12, p. 1989 (2004); An et al., Genome Inform. 15, p. 31 (2004) and Mol. Cell. Proteomics 4, p. 752, (2005)), and Laurie and Jackson (Bioinformatics 21, p. 1908 (2005)).

### (3) Preparing the Structure for the Subsequent Analysis

In the third step, the protein structure is prepared for the subsequent analysis. The preparation can involve reducing the size of the protein structure to include only residues in the vicinity of a binding site, which are relevant to the analysis. Unique descriptors (e.g., numbers) are assigned to the atoms of the amino acid residues of the binding site to distinguish them from the other residues and/or molecules contained in the protein structure for the purpose of the analysis. Atoms in the protein structure that are not expected to be relevant to the analysis, such as amino acid residues not expected to contact a potential ligand, and other atoms, such as solvent molecules, metal ions, and other ligands, can be marked to be ignored by the analysis. Atoms or amino acids relative to the analysis, in the vicinity of or contributing to the binding site, are termed to be representing the binding site.

### (4) Determining Geometric Descriptors for the Amino Acid Residues of the Target Protein Binding Site

The fourth step determines types and geometric descriptors (conformations) of the amino acid residues of the target protein binding site. The type of an amino acid can be determined based on the designation in the corresponding structural file available from a protein structural database or from an experimental procedure used to determine the protein structure. The type of an amino acid can be also determined from the atomic composition of residues composing the binding site. Subsequently, conformations of the amino acid residues composing the protein binding site are determined by measurement of all relevant torsion angles. The relevant torsion angles are all those angles necessary to unambiguously assign a conformation to an amino acid residue. The amino acid conformations can also be defined by other sets of structural descriptors, such as of intermolecular distances, angles, and torsion angles, or any combination of thereof.

### (5) Searching Protein Structural Database(s) and Collecting Data

In the fifth step of the procedure, structural database(s) are searched and data are collected. After the type and conformation of amino acid residues of the binding site are registered, a search of the protein structural database is conducted for selected (or all) amino acids in the binding site. Once an amino acid residue matching the type and conformation of a residue in the protein binding site is identified in the database, coordinates of the identified residue and all surrounding atoms within a certain radius (e.g., 2-6 Å) of the residue are recorded. Data points identified for each searched amino acid in the binding site are termed to correlate with that amino acid and are assigned its unique descriptor. By translational and rotational transformation of the entire recorded set of coordinates, all or selected atoms of the matched amino acid residues are aligned and the coordinates of the entire set are attached to the set of collected data, which in addition to the collected data can contain coordinates and descriptors for the protein and any atoms and molecules contained within. This process is repeated for all identified matches for all selected residues of the binding site.

In some instances, a given amino acid conformation may not be sufficiently represented in the structural database. Under such circumstances, the tolerance criteria for some torsion angles in the matched amino acid pair can be relaxed to allow identifying of a sufficient sample of data, which can contain 1,000-2,000 representations for each considered residue in the binding site. The threshold for deviation from the optimal torsion angle in the matched amino acids can be relaxed more for atoms less likely coming into a contact with a potential ligand. In the process of translating and rotating of the recorded set of coordinates, the alignment between the matched pair of residues can be adjusted to emphasize the placement of atoms that will be more likely in the contact with a potential ligand. The tolerance criteria might be adjusted as follows. If, for example, glutamine (GLN), comprising atoms (in PDB nomenclature) N, C, O, CA, CB, CG, CD, OE1, and NE2, is one of the amino acids of a binding site of a target protein, and is in contact with a docked molecule only through atoms OE1 and NE2, the tolerance threshold for backbone torsion angles Φ(phi) and Ψ(psi), and residue torsion angles N-C-CA-CB, O-C-CA-CB, and C-CA-CB-CG can be gradually increased from 1-50° starting from angles involving the most distant atoms, which in this case would be phi and psi angles followed by angles N-C-CA-CB, O-C-CA-CB, and C-CA-CB-CG. If a sufficient sample is not identified even after the tolerance threshold relaxation, some torsion angle can be omitted during the matching procedure, again starting with angles involving the most distant atoms.

The number of matched residues identified for any amino acid in the binding site can vary, although for better results their numbers should be kept similar, with a deviation of approximately 200 residues or less. To adjust for possible differences in the number of collected data points correlating with each residue, the data points are assigned weight to adjust for these differences. The weights are calculated according to the following formula:

$${w}_{i ( j )} = 1 - \frac{{n}_{j}}{N}$$

where
wᵢ₍ⱼ₎ is the weight of i^{th} data point correlating with residue j;
nⱼ is total number of matched residues identified for the residue j in the structural database; and
N is the total number of collected data points after the retention test as described below. Alternatively, for example if greater differences in number of collected data points among residues exist, the weights can be computed according to the following formula:

$${w}_{i ( j )} = \frac{{n}_{max}}{{n}_{j}}$$

where
wᵢ₍ⱼ₎ is the weight of i^{th} data point correlating with residue j;
nⱼ is total number of matched residues identified for the residue j in the structural database; and
nₘₐₓ is the largest number of matched residues identified in the database for a residue in a binding site.

For each matched residue identified in the protein structural database, the atoms of interest identified in its vicinity are assigned specific types. These types can include, but are not limited to, hydrogen bond donors, hydrogen bond acceptors, and apolar atoms. Assignment of atoms to each category can vary based on the specifics of each analysis. In one possible assignment method, the atom types using the PDB nomenclature are grouped as follows: apolar type includes atoms CB, CG, CG1, CG2, CD, CD1, CD2, CE, CE1, CE2, CE3, CH2, CZ, CZ2, CZ3; hydrogen bond acceptors include atoms O, OD1, OD2, OE1, OE2, OG, OG1, OH; and hydrogen bond donors include atoms N, ND1, ND2, NE, NE1, NE2, NH1, NH2, NZ.

Once the entire dataset is collected, a data point retention procedure can be applied to each point in the collected dataset. First, atoms of the matched residues identified in the database are deleted, so that only the locations of the surrounding atoms are retained. Subsequently, for each atom in every residue in the binding site, a distance of the closest adjacent data point of each considered type correlating with this residue is measured. Distances of data points collected for other residues in the binding site are compared to the distances of correlating data points of respective type closest to each atom in a residue. If any data point of a given type correlating with one amino acid residue is closer to an atom from another residue than any of its own data points of respective type, this data point is deleted from the dataset. Once this process is carried for each data point and all undesired data points are removed, the entire set is ready for further processing, which includes discretization and computation of distribution density factors that are employed in the optimization and scoring procedures. In addition, the collected dataset can be directly used in optimization methods, which discretize and compute distribution density factors directly for each atom position in a drug candidate molecule.

### (6) Discretizing the Collected Data

The sixth step discretizes the collected dataset superimposed on the protein surface. Discretization of data involves computation of weights for each data point applicable to a discrete position in a protein receptor using a membership functions. A useful spacing of the discrete positions in a protein binding site is 0.1-0.2 Å or 0.1-0.3 Å. The spacing can be adjusted for the purpose of a conducted analysis. For faster and less precise docking procedures, the spacing density can be reduced to 0.5 Å or higher. However, should lesser precision be desirable, the methods employing the density maxima computed according to procedure can be used instead with greater precision and faster computational procedure.

The membership functions employed in the discretization procedure are used to determine the magnitude of participation of each data point at probe positions formally placed into a protein binding site. The combined participation weights of data points at each probe position define functional overlap between data points and are used to determine the relative occurrence frequency for each considered atom type. The membership functions employed in the data discretization can be based on triangular, bell, trapezoidal, harvesine, and exponential functions. Use of more complex functions is possible, but requires greater computing overhead to implement. (The discretization can also be based on a simple compartmentalization of the protein target binding site followed by smoothing of the compartmentalized data.) The adjusted weights for each data point are computed based on the following formula:

wᵢ′=wᵢ*f(dᵢ)

where
wᵢ′ is data point's new weight;
wᵢ is data point's original weight; and
f(dᵢ) is the function that relates weight of i^{th} data point to its distance from a corresponding probe position.

The membership functions f(dᵢ) can be defined by height (or magnitude, which could be normalized to one) and width (the base of the function). For the purposes of this analysis, a Gaussian function with a Gaussian constant in a range of 5-20 and a cutoff distance of 1.4 Å is identified to give good results.

The frequency of occurrence (fⱼ) for all considered atom types at each probe position is computed as a sum of weights of corresponding data points in the effective probe radius computed using the membership functions as described above according to the following formula:

$${f}_{j} = {\sum }_{i = 1}^{n} {w}_{i}^{′}$$

where
wᵢ′ is the adjusted weight of a data point; and
n is the number of occurrences of a considered atom type in grid point's effective radius.

### (7) Computing Distribution Density Factors for Specific Atom Types and Their Storage on Specific Grid Points

The seventh step of the procedure converts the discretized frequencies of occurrence (fⱼ) into variables used for subsequent docking procedures. The frequencies fⱼ computed at each probe point location can be used directly for optimization procedures. Alternatively, they can be further converted into values relative to benchmark frequencies that could be expressed as an average occurrence frequency for each considered atom type or as an expected frequency of occurrence based on a statistical probability derived for representations of specific atom types in amino acid residues. This information can be expressed in multiple ways including, but not limited to, a natural or decadic logarithm of the ratio between the actual and benchmark value. For the purposes of scoring and optimization, procedures distribution density factors can be computed for each probe position as a natural logarithm of the ratio between recorded frequency and expected frequency computed for each probe position and for each atom type according to the formula:

$${Q}_{j} = ln \frac{{f}_{j}}{{p}_{j}}$$

where
Qⱼ is the distribution density factor of j^{th} probe position calculated separately for each atom type;
fⱼ is the observed occurrence frequency for each atom type; and
pⱼ is the expected frequency for each considered atom type calculated by the following equation:

$${p}_{j} = p * \frac{{\sum }_{j = 1}^{m} {\sum }_{l} {f}_{jl}}{m}$$

where
p is the relative probability of occurrence for each considered atom type calculated based on statistical analysis of large sample of protein structures (for the apolar, hydrogen bond donor, and hydrogen bond acceptor atom types described above the relative probabilities used are 0.421, 0.276, and 0.302, respectively);
fⱼₗ is the combined weight-adjusted frequency for all considered atom type l at j^{th} probe position; and
m is the number of effective probe positions (where sum of weights of all data points with an effective distance is one or higher) formally allocated in the protein binding site.

Once the distribution density factors have been computed for a protein target, they can be stored on grid points corresponding to the probe position at which they were computed. A useful grid point spacing is 0.1-0.2 Å or 0.1-0.3 Å. Wider spacing of the probes does not increase the precision of the computation and increases the amount of memory used in the computer storage device.

### (8) Computing Distribution Density Maxima

A local distribution density maximum is determined for each atom type by locating a point with the highest value of distribution density and designating that point as a local distribution density maximum. Subsequently, all data points within a specific radius (e.g., 1.0-1.5 Å) are no longer considered in the analysis. This procedure can be repeated until a distribution density threshold (e.g., Q=1.3) is reached. This threshold value can be set higher or lower depending on the range of probability density computed for each atom type.

### Docking a Candidate Molecule to a Protein Target

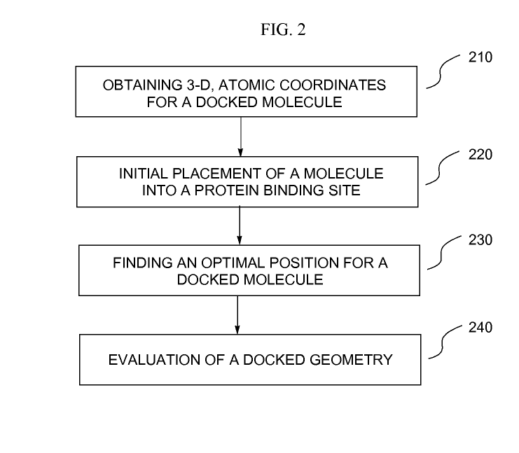

The docking procedure for identification of candidate molecules that bind to a protein target is shown in FIG. 2, and comprises the steps of: (1) obtaining a three-dimensional atomic coordinates of a candidate molecule, (2) placing the candidate molecule into an initial placement on the target protein binding site, (3) identifying an optimal candidate molecule position and orientation within the target protein binding site, and (4) evaluating the candidate molecule—protein target complex geometry. Steps 3 and 4 might be repeated with changes in the initial placement, orientation, and/or conformation of the candidate molecule.

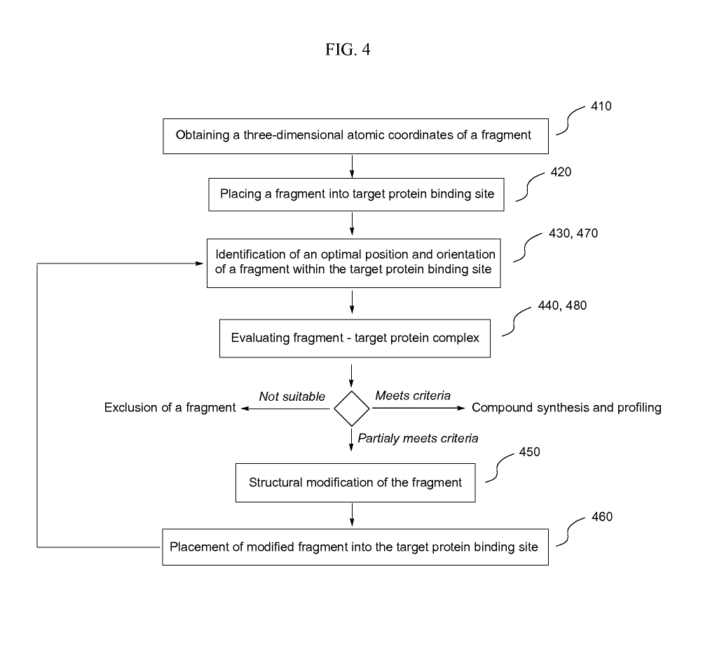

A method for designing molecules with affinity for a therapeutic protein target, augmented by the computed field of distribution densities according to one embodiment of the invention is shown in FIG. 4, and comprises the steps of: (1) obtaining a three-dimensional atomic coordinates of a fragment, (2) placing the fragment into the target protein binding site, (3) identifying an optimal position and orientation for the fragment within the target protein binding site, (4) evaluating the fragment-target protein complex, (5) modifying the structure of the fragment, (6) placing the modified fragment into the target protein binding site, (7) identifying an optimal position and orientation for the modified fragment within the target protein binding site, and (8) evaluating the modified fragment-target protein complex. Steps 2 and 3 may be repeated with changes in initial placement, orientation, and/or conformation of the fragment in order to determine an optimal fragment position in the target protein binding site, which may be associated with a highest local or global score above an acceptable threshold. Steps 5 through 8 may be repeated until established criteria are fulfilled.

### (1) Obtaining Three-Dimensional Coordinates of a Fragment Molecule

The first step in the fragment docking and optimization procedure involves determination of the three-dimensional geometry of a fragment molecule 410. The fragment molecule geometry can be represented by, for example, Cartesian coordinates, or internal coordinates comprising a set of bond lengths, angles, and torsional angles that unequivocally define molecular geometry. Such coordinates can be obtained by X-ray crystallography of the molecule, which might be available from a structural database such as Cambridge Crystallographic database. In addition, molecular structural coordinates can be estimated using theoretical structure calculations including ab initio techniques, semi-empirical techniques, molecular mechanics techniques or template-based coordinate generation methods implemented, for example, in software such as CONCORD (Tripos, Inc., St. Louis, Mo.), CORINA (University of Erlangen, Nürnberg, Germany), or other techniques. A conformational search can be performed using, currently available software packages such as Catalyst (Smellie et al., J. Chem. Inf. Comput. Sci. 235, p. 285 (1995); Smellie et al., J. Chem. Inf. Comput. Sci. 235, p. 295 (1995)). The coordinates of the individual conformers can be generated prior to the docking procedure and stored using a computer storage device, or they can be generated during the docking procedure. The selection of the appropriate technique depends on the type of docking procedure employed. Prior to proceeding to the next step, a selection process can be used to exclude less stable conformers on the basis of their relative energies, computed using structure energy calculations including ab initio, semi-empirical, or molecular mechanics techniques.

(2) Placing a Fragment into the Target Protein Binding Site

The second step in the fragment docking and optimization procedure involves the initial placement of the fragment molecule into the target protein binding site 420. Depending on the optimization procedure chosen, the initial placement can be based on a random selection of positional and rotational parameters, systematic rotational and translational positioning, or it can be determined based on matching of specific atoms of the fragment molecule with particular regions in a target protein binding site defined by the distribution density factors described in the previous section (FIG. 1). In the latter case, the initial placement of the fragment molecule is achieved through rotational and translational movement of the molecule to achieve the best alignment between the selected atoms in the molecule and the specific regions in a target protein binding site. To facilitate the initial placement of fragments into a target protein binding site, fragment molecules or their conformations can be prescreened to eliminate those with very low likelihood of fitting into the binding site. For example, if three distribution density maxima M1, M2, and M3 are selected, their mutual position can be represented by respective distances d(M1, M2), d(M1, M3), and d(M2, M3). In a docked molecule, a triplet of atoms of interest can be defined by their mutual distances d(A1,A2), d(A1,A3), and d(A2,A3). Thus, the individual distances between selected atoms in a fragment molecule and mutual distances of respective distribution density maxima can be compared. If the difference between respective distances is below certain threshold value, such a molecule or conformation is excluded from the docking analysis. If the corresponding distances are above the threshold value (e.g., 0.25-2.0 Å), the initial placement of the fragment molecule into a target protein binding site is accomplished by series of rotational and translational movements aimed to minimize the spatial distances between corresponding pairs of atoms in the docked fragment molecule and matched distribution density maxima. The rigid body placement algorithm minimizes the following equation:

$$I ( T , R ) = {\sum }_{j = 1}^{3} \vert Mj - Aj \vert$$

where
T is a translation vector;
R is a rotation 3×3 matrix;
Mj is a vector defining a position of the distribution density maximum j; and
Aj is a vector defining the position of the corresponding atom j in the docked fragment.

In the case of a small number of docked fragments, manual placement of each molecule can be carried out using an appropriate computer interface implemented in a computer storage device.

### (3) Identifying an Optimal Position for a Docked Fragment in a Protein Binding Site

The third step in the fragment docking and optimization procedure determines an optimal placement for a molecule in the target protein binding site 430. The placement procedure involves positioning of a fragment molecule in the field of distribution densities in order to maximize the overlap between positions of fragment atoms and areas of higher concentration of distribution density superimposed on a protein surface. This step can be a part of a procedure aimed at finding a position and orientation of a fragment in the target protein binding site that represents the highest achievable score globally or locally depending on the purpose of the analysis. The overall score for any fragment molecule is computed based on comparison between distribution densities in locations of atoms in a docked fragment and optimal distribution densities typical for atoms present in ligands with known high affinity for a given protein target. If freely rotatable bonds are present in a docked molecule, conformational sampling of the docked fragment is undertaken and a score for such a flexible molecule is assigned based on the highest score identified for any conformer in the conformational sample. The conformational sampling can be undertaken prior to the placement procedure, which approaches the predefined conformation stored in a computer device as rigid body molecules. In addition, an incremental construction algorithm can be applied, using procedures implemented, for example, in FlexX (Rarey et al., J. Mol. Biol. 261, p. 470 (1996); Rarey et al., Proteins 34, p. 17 (1999); Rarey et al., Bioinformatics 15, p. 243 (1999)), and Hammerhead (Welch et al., Chemistry & Biology 3, p. 449 (1996)) programs.

The optimal placement of a docked fragment can be achieved using a variety of stochastic and combinatorial algorithms described previously, with the incorporation of functions assessing favorability of placement on the basis of current invention. Computer packages implementing stochastic docking methods include AutoDock (Goodford, J. Med. Chem. 28, p. 849 (1985); Goodsell, and Olson, Proteins 8, p. 195 (1990)), GOLD (Jones et al., J. Mol. Biol. 267, p. 727 (1997)), TABU (Westhead et al., J. Comput. Aided Mol. Des. 11, p. 209 (1997); Baxter et al., Proteins 33, p. 367 (1998)), and Stochastic Approximation with Smoothing (SAS) (Diller et al., J. Comput. Chem. 20, p. 1740 (1999)). Examples of the software packages implementing combinatorial docking methods include DOCK (Kuntz et al., J. Mol. Biol. 161, p. 269 (1982); Kuntz et al., Science 257, p. 1078 (1992); Makino and Kuntz J. Comput. Chem. 18, p. 1812 (1997)), FlexX (Rarey et al., J. Mol. Biol. 261, p. 470 (1996); Rarey et al., Proteins 34, p. 17 (1999); Rarey et al., Bioinformatics 15, p. 243 (1999)), and Hammerhead (Welch et al., Chemistry & Biology 3, p. 449 (1996)).

The procedure for identifying the optimal overlap between a fragment molecule and the distribution density factors can employ many of the known optimization algorithms. These algorithms include, but are not limited to: systematic searches for all possible translational and rotational orientations; Broyden-Fletcher-Goldfarb-Shanno (BFGS), Steepest Descent, and conjugate gradient methods (Shanno, Mathematics of Operations Research 3, p. 244 (1978)); as well as fast Fourier methods (Gabb et al., J. Mol. Biol. 272, p. 106, (1997); Mandell et al., Protein Eng. 14, p. 105, (2001); Vakser, Protein Eng. 8, p. 371, (1995); Meyer et al., J. Mol. Biol. 264, p. 199, (1996); Ben-Zeev and Eisenstein, Proteins 52, p. 24, (2003); Chen et al., Proteins 52, p. 80, (2003)). The docking methods using the distribution density factors in the present invention can employ stochastic and as well as combinatorial ligand docking procedures.

For the purposes of fast docking and scoring involving a large number of fragment molecules and their multiple conformers, a location of favorable interaction regions within a protein binding site can be identified as a local distribution density maximum within a protein binding site. A procedure for selection of favorable binding site locations, termed ‘hot spots,’ in a target protein calculated based on Lennard-Jones and Coulombic potentials was described by Goodford in “Computational Procedure for Determining Energetically Favorable Binding Sites on Biologically Important Macromolecules” (Goodford, J. Med. Chem. 28, p. 849, (1985)). In contrast to existing methods, the ‘hot spots’ in the target protein binding site can be determined using distribution densities described in this invention by identifying local distribution density maxima. A local distribution density maximum is determined for each atom type by locating a point with the highest value of distribution density and designating that point as a local distribution density maximum. Subsequently, all data points within a specific radius (e.g., 1.0-1.5 Å) are no longer considered in the analysis. This procedure can be repeated until a distribution density threshold (e.g., Q=1.3) is reached. This threshold value can be set higher or lower depending on the range of probability density computed for each atom type.

The geometry optimization procedure is aimed to identify a maximum possible overlap between all (or selected) atoms in a ligand molecule and the regions of the highest distribution densities for the respective atom types in the protein binding site. The docking procedure can include optimization of the following equation:

$$I ( T , R , B ) = {\sum }_{i = 1}^{n} {CQ}_{i}$$

where
n is the number of atoms in a docked molecule;
Qᵢ is the distribution density factor at location of the i^{th} atom in a fragment molecule;
I(T,R,B) represents the position of the fragment molecule in a binding site given by translational (T), rotational (R), and rotatable bond parameters (B); and
C is the proportionality constant for the considered atom type.

The computed values of the distribution density factors Qᵢ are pre-calculated and stored at discrete positions distributed within a protein binding site or computed during geometry optimization from collected data points at locations of atoms in the docked fragment molecule. Computation of the density factors during optimization at fragment atom positions affords precise results in terms of relative positioning of the fragment molecule and the protein target. On the other hand, pre-calculation of the density factors affords a faster computational procedure and provides a favorable compromise between the speed and precision of the computational procedures.

Ultra-fast docking procedures can be carried out using the following formula:

$$I ( T , R , B ) = {\sum }_{i = 1}^{n} {CD}_{i}$$

where
n is the number of atoms in a docked molecule;
Dᵢ is the distance between i^{th} atom in the fragment molecule and respective local distribution density maximum;
I(T,R,B) represents the position of the fragment molecule in a binding site given by translational (T), rotational (R), and rotatable bond parameters (B); and
C is the proportionality constant for the considered atom type.

To further improve the performance of optimization procedures described above, especially in the instances when a fragment molecule is not completely buried in the protein surface, the algorithms for optimization of fragment-target protein geometries can factor in the level of desolvation for each atom in the fragment molecule. Such an approach puts a greater emphasis on the atoms in contact with the target protein and deemphasizes the atoms exposed to the solvent. The optimal position can be identified using a formula selected from the group of:

$$I ( T , R , B ) = {\sum }_{i = 1}^{n} {CQ}_{i} {F}_{i} ;$$

$$and$$

$$I ( T , R , B ) = {\sum }_{i = 1}^{n} {CD}_{i} {F}_{i}$$

where
Fᵢ represents proportion of atom's surface proportion in the contact with the protein surface.

The procedures differ in their accounting for the fragment molecule's flexibility, i.e., changes of molecular geometry due to changes of torsion angles between atoms joined through rotatable bonds.

### (4) Evaluating the Fragment-Target Protein Complex

The fourth step in the fragment docking and optimization procedure involves evaluating the fragment-target protein complex 440. This step might involve computation of a score for a docked fragment. The scoring method for the evaluation of the fragment-target protein complex is based on the following equation:

$$Score = {\sum }_{i = 1}^{n} C * \frac{{Q}_{i}}{Q}$$

where
Qᵢ is the distribution density factor or any other measure of occurrence frequency of the atom type at its location or at the location of the nearest grid point in the binding site;
Q is the optimal distribution density factor or any other measure of occurrence frequency for the considered atom type; and
C is the proportionality constant for the considered atom type.

The Q values are set based on typical occurrence frequencies for each considered atom observed in the experimental protein three-dimensional structures. When the distribution density factors are considered, the Q value for apolar atoms and hydrogen bond donors is around 1.3. The Q values for hydrogen bond acceptors are kept approximately 20% higher. The proportionality constant is set approximately three times higher for hydrogen bond donors and acceptors, as their misplacement is considerably costlier energetically, as compared to misplacement of apolar atoms. The Q values might further account for the level of atom's solvent exposed surface area. Furthermore, the Q values can be computed specifically for each analyzed target protein by taking, for example, an average value of computed distribution density maxima above a specific threshold value (e.g., Q=1.3 for apolar atoms and Q=1.7 for hydrogen bond donors and acceptors). In addition to the above described scoring procedure, proper alignment of atoms participating in hydrogen bonds between a fragment and the protein residues can be evaluated to ascertain necessary orbital overlap between hydrogen bond donors and acceptors.

Evaluating the fragment-target protein complex also may involve computation of distribution density maxima coverage (DDMC) by the fragment. The coverage of the distribution density maxima can be determined, for example, by computing the percentage of distribution density maxima situated within a specific distance (e.g., <1.5 Å) from an atom of equivalent type contained in the fragment. The type of a distribution density maximum is determined based on the predominant type of distribution frequency at its location. The coverage of distribution density maxima might be computed for all types of maxima combined, or it can be computed for each atom type separately, according to the following formulas:

$${DDMC}_{Total} = \frac{{CM}_{Total}}{{TM}_{Total}} \times 100$$

$${DDMC}_{HD} = \frac{{CM}_{HD}}{{TM}_{HD}} \times 100$$

$${DDMC}_{HA} = \frac{{CM}_{HA}}{{TM}_{HA}} \times 100$$

$${DDMC}_{AP} = \frac{{CM}_{AP}}{{TM}_{AP}} \times 100$$

where
DDMC_{Total}, DDMC_{HD}, DDMC_{HA}, and DDMC_{AP} are total distribution density maxima coverage for all, hydrogen bond donor, hydrogen bond acceptor, and apolar maxima, respectively;
CM_{HD}, CM_{HA}, and CM_{AP} are number of covered distribution density maxima for hydrogen bond donor, hydrogen bond acceptor, and apolar types, respectively; and
TM_{HD}, TM_{HA}, and TM_{AP} are total number of considered distribution density maxima for hydrogen bond donor, hydrogen bond acceptor, and apolar types, respectively.

If the protein's native ligand is used as a template for the structure-based design, DDMC_{Total}, DDMC_{HD}, DDMC_{HA}, and DDMC_{AP} can be evaluated relative to the density maxima covered by the native ligand, according to the following formulas:

$${DDMC}_{Total}^{′} = \frac{{CM}_{Total ( Fragment )}}{{TM}_{Total ( NativeLigand )}} \times 100$$

$${DDMC}_{HD}^{′} = \frac{{CM}_{HD ( Fragment )}}{{TM}_{HD ( NativeLigand )}} \times 100$$

$${DDMC}_{HA}^{′} = \frac{{CM}_{HA ( Fragment )}}{{TM}_{HA ( NativeLigand )}} \times 100$$

$${DDMC}_{AP}^{′} = \frac{{CM}_{AP ( Fragment )}}{{TM}_{AP ( NativeLigand )}} \times 100$$

where
DDMC′_{Total}, DDMC′_{HD}, DDMC′_{HA}, and DDMC′_{AP} represent fragment's relative distribution density maxima coverage for all, hydrogen bond donor, hydrogen bond acceptor, and apolar maxima, respectively.

Under some circumstances, the reference distribution density maxima coverage can be computed using a non-native ligand or fragment docked in the binding site.

Acceptable level of coverage of distribution density is established based on geometric considerations specific for each target protein structure. It is essential that a distribution density maximum representing a hydrogen bond acceptor type and a hydrogen bond donor type are covered by the fragment. This requirement is especially significant if the fragment is blocking access of solvent molecules (e.g., water molecules) to the target protein binding site.

Evaluating the fragment-target protein complex also may involve estimation of changes in the solvent-accessible surface area upon binding of the fragment to the target protein and comparison of these values to the changes characteristic for the known ligand-protein complexes.

In this fourth step, criteria for acceptance of a fragment as a viable candidate molecule may be adopted. All or some fragment or fragment-target protein complex characteristics satisfying established threshold criteria can warrant progression to the subsequent steps of the fragment optimization procedure.

### (5) Modifying the Structure of the Fragment

The fifth step in the fragment docking and optimization procedure involves structural modification of the fragment 450. In one aspect, the structural modification of a fragment can enhance its affinity toward the therapeutic target. In another aspect, the structural changes can target a chemical composition characteristic of a drug, improving, for example, its predicted physicochemical, pharmacokinetic, or toxicological properties or its specificity for the therapeutic target. Structures of known, safe drugs can be used as guidance for suitable structural changes. Synthetic feasibility of a fragment is an important factor in determining suitable changes in chemical composition.

The structural modification of the fragment can involve, for example, deletion of atoms, replacement of one atom type with another, addition of an atom or a functional group, or any combination thereof. The structural modification can also involve combining two or more suitably positioned fragment molecules (e.g., associated with a high score), through a covalent bond or a structural linker composed of two or more atoms, in a way that does not disturb their optimal positioning in the target protein binding site. The fragment structural modification can be carried out using any software facilitating such modifications. The software may provide a graphical interface for building molecules and molecular geometry optimization routines, including, for example, molecular mechanics, semi-empirical, and ab initio computations. Available software that can be utilized for fragment structural modification includes, for example, Spartan (Wavefunction), SYBYL (Tripos), and MacroModel (Schrödinger). The structurally modified fragment should be subjected to conformer distribution evaluation and to geometry optimization to ascertain that the expected binding geometry represents the fragment's optimal geometry (associated, for example, with the lowest energy) or a geometry structurally close to the optimal geometry. The structural modeling, including the conformer distribution analysis, can also serve to estimate total entropy change associated with the binding of the fragment.

(6) Placing the Modified Fragment into the Target Protein Binding Site

The sixth step in the fragment docking and optimization procedure involves placement of the modified fragment into the target protein binding site 460. The location and orientation of the modified fragment should correspond to the position of the fragment prior to the modification. Because some atoms contained by the fragment before modification may be replaced or deleted and the geometry of the modified fragment may thus be altered in comparison to the original fragment, placement of the modified fragment should emphasize position and orientation of atoms that can be unequivocally identified in both the original and modified fragment. Position and orientation of hydrogen bond donors and acceptors should have priority over position and orientation of apolar atoms.

For example, if A1, A2, and A3 are atoms in the original fragment and A1′, A2′ and A3′ are corresponding atoms in the modified fragment, then the initial placement of the modified fragment into a target protein binding site is accomplished by series of rotational and translational movements aimed to minimize the spatial distances between corresponding pairs of atoms. The rigid body placement algorithm minimizes the following equation:

$$I ( T , R ) = {\sum }_{j = 1}^{n} \vert Aj - {Aj}^{′} \vert$$

where
T is a translation vector;
R is a rotation 3×3 matrix;
n is number of corresponding atoms in the original and modified fragment considered during the placement of the modified fragment;
Aj is a vector defining a position of the atom j in the original fragment; and
Aj′ is a vector defining the position of the corresponding atom j in the modified fragment.
(7) Identifying an Optimal Position and Orientation for the Modified Fragment within the Target Protein Binding Site

The seventh step in the fragment docking and optimization procedure determines an optimal position for the modified fragment 470. The procedure for optimization of the geometry of the modified fragment-target protein complex is the same as that of step (3), used to optimize the position of the original fragment in the target protein binding site.

### (8) Evaluating the Modified Fragment-Target Protein Complex

The eighth step in the fragment docking and optimization procedure involves evaluation of the modified fragment-target protein complex 480. The evaluation criteria are similar to the considerations of the structural modification in step (5), and involve, first, the strength of the complex between the fragment and the target protein and, second, the physicochemical, pharmacokinetic, and overall “drug-like” properties of the fragment. The latter properties include, for example, molecular weight, number of hydrogen bond donors and acceptors, and apolar solvent accessible surface area.

Determination of the strength of interaction between a fragment and a target protein structure is based on the computation of a score and distribution density coverage as described in step (4). It might also involve assessment of proper alignment of atoms participating in hydrogen bonds between a fragment and a protein target. The acceptance criteria in the fragment optimization cycle should be based on the selected threshold values for the score and distribution density coverage. The threshold values may be computed for each protein target separately, respective for each target protein complex structure, based, for example, on benchmark values computed for native ligands. Native ligands bound with higher affinities (i.e. with more favorable dissociation constants/K_{d} values) may provide better benchmarks for evaluating of a fragment's affinity toward a therapeutic target.

This step determines whether fragment attributes meet the selected threshold criteria. Fragment meeting these criteria might be advanced in a drug discovery process, through chemical synthesis, biological testing, and other drug candidate profiling methods.

### Identification of Biologically Active Drug Candidate Molecules

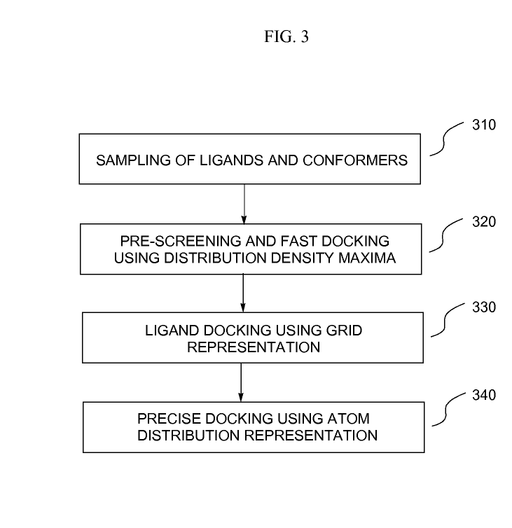

One embodiment of a generalized technique for identifying biologically active drug candidates is depicted in FIG. 3. Initially, a procedure for sampling of candidate molecule conformations for selected number of potential drug candidates is carried out to generate the initial geometries of molecules to be used in the docking procedures 310. Pre-screening of the generated candidate molecule geometries is carried out using a similarity search, comparing the spatial arrangement of distribution density maxima or clusters of grid points representing locations of high atom distribution frequencies with the structural disposition of atoms in the docked molecules. In addition to weeding out the candidate molecules having minimal probability of binding to the protein target, module 320 can be used to determine starting geometries for the protein-candidate molecule complexes used by the subsequent methods. The procedures 330 and 340 provide the means for more precise geometry optimization and assessment of relative propensity of candidate molecules to bind to the considered protein. Both procedures give similar results in terms of predicted geometries of target protein-candidate molecule complexes. While the precision of procedure 330 is limited by the probe spacing, procedure 340 allows greater computational precision. However, considering the error associated with experimentally-determined structures and the dynamic nature of protein structures in general, the outcomes of procedure 330 with 0.1-0.2 Å or 0.1-0.3 Å grid spacing can suffice. The initial candidate molecule geometries used in procedures 320, 330, and 340 can be generated using any of the known programs, including Catalyst (Smellie et al., J. Chem. Inf. Comput. Sci. 235, p. 285, (1995); and Smellie et al., J. Chem. Inf. Comput. Sci. 235, p. 295, (1995)). If combinatorial methods using an incremental construction approach are used, module 320 can be used for rapid pre-screening of smaller molecular fragments whose positions and orientations can be further optimized using the procedure based on the grid representation 330. Attachment of additional molecular fragments and their orientations can be optimized using the same techniques as described above.

### EXAMPLES

The following two examples demonstrate the use of distribution density maxima in the process of optimizing a fragment's affinity for a therapeutic target. Specifically, calculated scores for fragment-target protein complex geometry and calculated fragment coverages of distribution density maxima are shown to be effective virtual screening criteria for optimizing a fragment's affinity for a therapeutic target. This procedure of fragment docking and optimization has the speed and accuracy appropriate for use in a pharmaceutical research setting.

### Example 1

### Fragment Design for Streptavidin Affinity

Computation of distribution densities was carried out according to the procedure described above, using the streptavidin-biotin complex. The target protein coordinates were obtained from the PDB (2IZG). The target protein binding site was identified based on the position of the native ligand (biotin) within the target protein crystal structure. First, the protein structure was prepared for the analysis. All residues beyond a distance of 7.5 Å from the location of the native ligand were deleted. Atoms correlating with the native ligand were marked as such to be treated accordingly during the data collection and the subsequent analysis. All amino acid residues within the distance of 5.0 Å from the native ligand were marked as the residues of the protein binding site. TABLE 1 lists the amino acid residues of the binding site, residue torsion angles used in the database search, and their respective (+/−) tolerance threshold values. The relevant torsion angles in PDB nomenclature are as follows: VAL: α1: C-CA-CB-CG1; PHE: α1: C-CA-CB-CG, α2: CA-CB-CG-CD1; ASP: α1: C-CA-CB-CG, α2: CA-CB-CG-OD1; LEU: α1: C-CA-CB-CG, α2: CA-CB-CG-CD1; ASN: α1: C-CA-CB-CG, α2: CA-CB-CG-OD1; TYR: α1: C-CA-CB-CG, α2: CA-CB-CG-CD1; SER: α1: C-CA-CB-OG; THR: α1: C-CA-CB-OG1; TRP: α1: C-CA-CB-CG, α2: CA-CB-CG-CD1.

TABLE 1

| | | | | | | | Identified |
|---|---|---|---|---|---|---|---|
| Residue | φ | ψ | α1 | α2 | α3 | α4 | Residues |
| ASN 23 | — | — | 6 | 5 | — | — | 1144 |
| LEU 25 | — | — | 3 | 1 | — | — | 1136 |
| SER 27 | 15 | 15 | 5 | — | — | — | 1177 |
| TYR 43 | — | — | 8 | 7 | — | — | 1348 |
| SER 45 | 12 | 12 | 5 | — | — | — | 1275 |
| VAL 47 | — | 3 | 4 | — | — | — | 1394 |
| GLY 48 | 5 | 5 | — | — | — | — | 1382 |
| ASN 49 | 6 | 8 | — | — | — | — | 1088 |
| ALA 50 | 3 | 3 | — | — | — | — | 1392 |
| TRP 79 | — | — | 4 | 3 | — | — | 1278 |
| ALA 86 | 4 | 4 | — | — | — | — | 1401 |
| SER 88 | 6 | 6 | 4 | — | — | — | 1421 |
| THR 90 | 7 | 7 | 5 | — | — | — | 1458 |
| TRP 92 | — | — | 8 | 7 | — | — | 1096 |
| TRP 108 | — | — | 8 | 7 | — | — | 1126 |
| LEU 110 | — | — | 3 | 2 | — | — | 1762 |
| ASP 128 | — | — | 5 | 1 | — | — | 1212 |

The fragment docking and optimization procedure was carried out according to the procedure described above, using Spartan software (Wavefunction, Inc., Irvine, Calif.) and the fragments shown in TABLE 2. The optimal local position for each fragment was identified using a stochastic rigid docking optimization procedure as described. TABLE 3 lists scores and relative distribution density maximum coverages computed for the individual fragments. The scores were calculated using the formula described in step (4), with C=3 for hydrogen bond acceptors and C=1 for apolar atoms. Q values were computed as an arithmetic average of all density maxima identified for each atom type. The relative distribution density maximum coverages (DDMC′) were computed using the DDMC of the native ligand, biotin (FRG11), as a reference. The affinities of individual fragments for the protein target increase with increased coverage of the distribution density maxima, reaching a maximum in this case with biotin. Thus, fragments FRG01-05 may not have considerable affinity for the protein target. For the purposes of fragment optimization the relative total and apolar coverages should each be ≧around 60; however, this value may vary based on the particular target and reference used in the analysis.

TABLE 2

| Fragment | Structure |
|---|---|
| FRG01 | 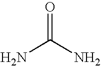 |
| FRG02 | 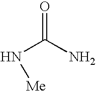 |
| FRG03 | 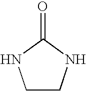 |
| FRG04 | 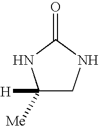 |
| FRG05 | 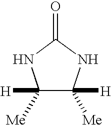 |
| FRG06 | 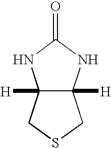 |
| FRG07 | 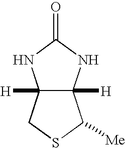 |
| FRG08 | 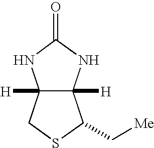 |
| FRG09 | 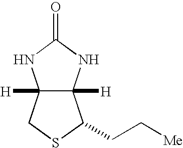 |
| FRG10 | 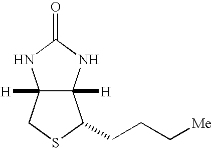 |
| FRG11 | 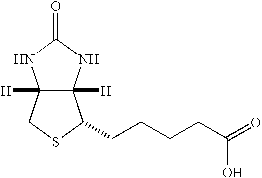 |

TABLE 3

| | | DDMC′ | DDMC′ | DDMC′ | DDMC′ |
|---|---|---|---|---|---|
| Fragment | Score | (Total) | (Apolar) | (HB Donor) | (HB Acceptor) |
| FRG01 | 0.95 | 26 | 4 | 100 | 42 |
| FRG02 | 0.94 | 34 | 18 | 100 | 42 |
| FRG03 | 0.93 | 35 | 18 | 100 | 42 |
| FRG04 | 0.96 | 42 | 27 | 100 | 42 |
| FRG05 | 0.95 | 43 | 27 | 100 | 42 |
| FRG06 | 0.95 | 54 | 45 | 100 | 42 |
| FRG07 | 0.95 | 60 | 50 | 100 | 42 |
| FRG08 | 0.96 | 66 | 64 | 100 | 42 |
| FRG09 | 0.95 | 78 | 91 | 100 | 42 |
| FRG10 | 0.97 | 88 | 100 | 100 | 42 |
| FRG11 | 0.94 | 100 | 100 | 100 | 100 |

### Example 2

### Fragment Design for CDK2 Affinity

Computation of distribution densities was carried out according to the procedure described above, using a human cyclin dependent kinase 2 (CDK2)-staurosporine complex. The target protein coordinates were obtained from the PDB (1AQ1). The target protein binding site was identified based on the position of the native ligand (staurosporine) within the target protein crystal structure. First, the protein structure was prepared for the analysis. All residues beyond a distance of 7.5 Å from the location of the native ligand were deleted. Atoms correlating with the native ligand were marked as such to be treated accordingly during the data collection and the subsequent analysis. All amino acid residues within the distance of 5.0 Å from the native ligand were marked as the residues of the protein binding site. TABLE 4 lists the amino acid residues of the binding site, residue torsion angles used in the database search, and their respective (+/−) tolerance threshold values. The relevant torsion angles in PDB nomenclature are as follows: VAL: α1: C-CA-CB-CG1; PHE: α1: C-CA-CB-CG, α2: CA-CB-CG-CD1; ASP: α1: C-CA-CB-CG; LEU: α1: C-CA-CB-CG, α2: CA-CB-CG-CD1; ASP: α1: C-CA-CB-CG, α2: CA-CB-CG-OD1; THR: α1: C-CA-CB-OG1; ILE: α1: C-CA-CB-CG2, α2: CA-CB-CG2-CD1; LYS: α3: CB-CG-CD-CE, α4: CG-CD-CE-NZ; GLU: α2: CA-CB-CG2-CD; α3: CB-CG-CD-OE1.

TABLE 4

| | | | | | | | Identified |
|---|---|---|---|---|---|---|---|
| Residue | φ | ψ | α1 | α2 | α3 | α4 | Residues |
| LYS 9 | 5 | 5 | — | — | — | — | 1366 |
| ILE 10 | — | — | 5 | 3 | — | — | 1002 |
| GLY 11 | 7 | 7 | — | — | — | — | 1235 |
| GLU 12 | 7 | 7 | — | — | — | — | 1361 |
| GLY 13 | 4 | 4 | — | — | — | — | 1612 |
| THR 14 | 4 | — | 5 | — | — | — | 1319 |
| VAL 18 | 4 | 4 | 3 | — | — | — | 1800 |
| ALA 31 | 5 | 5 | — | — | — | — | 1327 |
| LYS 33 | — | — | — | — | 22 | 6 | 1139 |
| VAL 64 | 14 | 14 | 5 | — | — | — | 1237 |
| PHE 80 | — | — | 3 | 2 | — | — | 1163 |
| GLU 81 | 5 | 3 | — | — | — | — | 1482 |
| PHE 82 | — | — | 4 | 3 | — | — | 1386 |
| LEU 83 | 11 | 50 | — | — | — | — | 1008 |
| HIS 84 | 7 | 7 | — | — | — | — | 1006 |
| GLN 85 | — | 2 | — | — | — | — | 1039 |
| ASP 86 | — | — | 7 | 5 | — | — | 1131 |
| GLN 131 | 4 | 2 | — | — | — | — | 1408 |
| ASN 132 | 7 | 7 | — | — | — | — | 1600 |
| LEU 134 | — | — | 4 | 1 | — | — | 1271 |
| ALA 144 | 5 | 5 | — | — | — | — | 1582 |
| ASP 145 | — | — | 5 | 4 | — | — | 1653 |
| GLU 162 | — | — | — | 4 | 3 | — | 1720 |

The fragment docking and optimization procedure was carried out according to the procedure described above, using Spartan software (Wavefunction, Inc., Irvine, Calif.) and the fragments shown in TABLE 5. The optimal local position for each fragment was identified using a stochastic rigid docking optimization procedure as described. TABLE 6 lists scores and DDMCs computed for the individual fragments. The scores were calculated using the formula described in step (4), with C=3 for hydrogen bond acceptors and C=1 for apolar atoms. Q values were computed as an arithmetic average of all density maxima identified for each atom type. The relative distribution density maximum coverages (DDMC′) were computed using the DDMC of the native ligand, staurosporine (FRG01), as a reference. The affinities of individual fragments for the protein target increase with increased coverage of the distribution density maxima, reaching a maximum in this case with staurosporine. Thus, fragments FRG 06-08 may not have considerable affinity for the protein target. For the purposes of fragment optimization the relative total and apolar coverages should each be ≧around 60; however, this value may vary based on the particular target and reference used in the analysis.

TABLE 5

| Fragment | Structure |
|---|---|
| FRG01 | 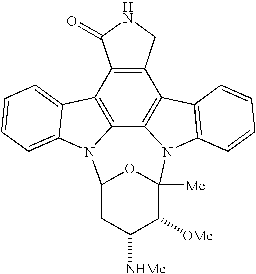 |
| FRG02 | 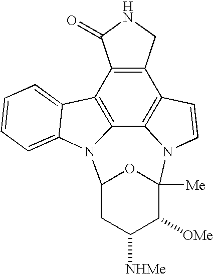 |
| FRG03 | 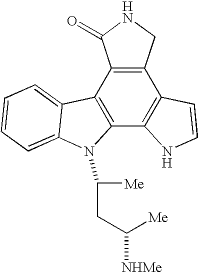 |
| FRG04 | 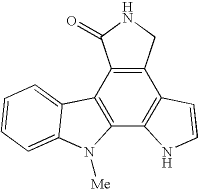 |
| FRG05 | 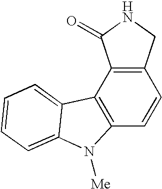 |
| FRG06 | 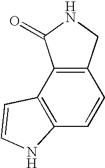 |
| FRG07 | 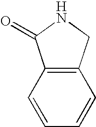 |
| FRG08 | 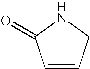 |

TABLE 6

| | | DDMC′ | DDMC′ | DDMC′ | DDMC′ |
|---|---|---|---|---|---|
| Fragment | Score | (Total) | (Apolar) | (HB Donor) | (HB Acceptor) |
| FRG01 | 0.74 | 100 | 100 | 100 | 100 |
| FRG02 | 0.72 | 84 | 76 | 100 | 100 |
| FRG03 | 0.61 | 68 | 64 | 100 | 100 |
| FRG04 | 0.81 | 59 | 62 | 100 | 100 |
| FRG05 | 0.91 | 56 | 58 | 100 | 100 |
| FRG06 | 0.98 | 48 | 58 | 100 | 100 |
| FRG07 | 0.98 | 34 | 45 | 100 | 100 |
| FRG08 | 0.99 | 22 | 30 | 100 | 100 |

### Implementation of the Methods

The methods described in this invention can be implemented using any device capable of implementing these methods. The devices that can be used include, but are not limited to, electronic computational devices, including computers of all types. Examples of computer systems that may be used include, but are not limited to, a Pentium based desktop computer or server, running Microsoft Windows, UNIX or Linux based operating platform, or any other suitable operating platform. Such computer systems can be readily purchased, for example, from Dell, Inc., Hewlett-Packard, Inc., or Compaq Computers, Inc.

When the methods are implemented in a computer, the computer program that may be used to configure the computer to carry out the steps of the methods may be contained in any computer-readable medium capable of containing the computer program. Examples of computer-readable media that may be used include but are not limited to diskettes, hard drives, CD-ROMs, DVDs, HD DVDs, Blue-ray Discs, ROM, RAM, punch cards and other memory and computer storage devices. The computer program that may be used to configure the computer to carry out these steps of the methods may also be provided over an electronic network, for example, over the internet, world-wide-web, an intranet, or other network. The network can be wired or wireless.

In one example, the methods described herein can be implemented in a system comprising a processor and a computer-readable medium that includes program code for causing the system to carry out the steps of the methods described herein. The processor may be any processor capable of carrying out the operations needed for implementation of the methods. The program code may be any code that when implemented in the system can cause the system to carry out the steps of the methods described herein. Examples of program code means include but are not limited to instructions to carry out the methods described herein written in a high level computer language such as C++, Java, or Fortran; instructions to carry out the methods described in this patent written in a low level computer language such as assembly language; or instructions to carry out the methods described in this patent in a computer executable form such as compiled and linked machine language.

The output from implementation of the methods described herein may be embodied in any medium capable of containing the output and may also be embodied in a computer storage or memory devices capable of containing the output. Examples of media that may be used include, but are not limited to diskettes, hard drives, CD-ROMs, and DVDs. Output from implementation of the methods described in this patent may also be provided over an electronic network, for example over the internet, world-wide-web, an intranet, or other network. In such a case, a user of the information may access the information through any device capable of transmitting the information to the user, including but not limited to computer monitors, CRTs, telephones, projection devices, paper images and text. A person becoming aware of the information generated as an output from the methods described in this patent may use the information in variety of ways including the uses described in the next section. A person may become aware of the information generated as an output from the methods described in this patent in a variety of ways including but not limited to accessing the information via a computer network, accessing the information telephonically, and accessing the information in a written form.

### Uses of the Methods

The methods described may be used in variety of ways including, but not limited to, identification of molecules capable of binding to target proteins that may possess biological activity induced by binding to that target. Molecules discovered by the methods of this invention can be used as, but not limited to, pharmaceuticals, herbicides, fungicides, pesticides, and chemical weapons. The methods of this invention can be also used to identify classes of compounds containing structural motifs that may allow them to bind to target molecules such as, but not limited to, proteins, DNA, and RNA.

The present invention is not to be limited in scope by the specific embodiments disclosed in the examples, which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims. Those skilled in the art will recognize, or be able to ascertain, using no more than routine experimentation, numerous equivalents to the specific embodiments described specifically herein. Such equivalents are intended to be encompassed in the scope of the following claims.

A number of references have been cited herein, the entire contents of which have been incorporated herein by reference.

What is claimed is:

1. A method for obtaining structural data representing a target protein binding site for determining a candidate molecule's ability to binding to the target protein binding site, comprising the steps of:
a) determining type and conformation of a plurality of amino acids of a ligand binding site on a three-dimensional target protein structure;
b) searching a structure database for amino acids matching the type and conformation of an amino acid of the binding site;
c) extracting three-dimensional coordinates of the atoms of a matched amino acid and atoms surrounding the matched amino acid into a coordinate set;
d) moving the coordinate set with respect to the searched amino acid until the matched amino acid is aligned with the searched amino acid;
e) assigning types and descriptors to the atoms of matched amino acids and atoms surrounding those matched amino acids, wherein the descriptors indicate that those atoms correlate with the searched amino acid; and
f) producing a binding site data set, wherein each data point of the set comprises coordinates and type of an atom surrounding a matched amino acid,
wherein the binding site data set is used for determining a candidate molecule's ability to bind a target protein.

2. The method of claim 1, further comprising repeating steps b) to d) for another amino acid of the binding site.

3. The method of claim 1, further comprising the step of deleting from the binding site data set each data point of a given type that is geometrically closer to an amino acid with which it does not correlate than that amino acid's data point of the same type.

4. The method of claim 1, wherein each data point is weighted according to the following equation:
$${w}_{i ( j )} = 1 - \frac{{n}_{j}}{N}$$
wherein wᵢ₍ⱼ₎ is the weight of i^{th} data point correlating with searched amino acid j; nⱼ is total number of matched amino acids identified for the searched amino acid j; and N is the final number of data points in the set.

5. The method of claim 1, wherein the each data point is weighted according to the following equation:
$${w}_{i ( j )} = \frac{{n}_{max}}{{n}_{j}}$$
wherein wᵢ₍ⱼ₎ is the weight of i^{th} data point correlating with searched amino acid j; nⱼ is total number of matched amino acids identified for the searched amino acid j; and nₘₐₓ is the maximum number of matched amino acids.

6. The method of claim 2, further comprising the steps of:
a) superimposing a grid comprising a plurality of grid points and the binding site data set;
b) selecting all data points within a selected distance from a given grid point;
c) assigning a weight to each selected data point according to its distance from the given grid point; and
d) calculating an occurrence frequency for each atom type at each given grid point.

7. The method of claim 6, wherein the weight of a data point is calculated according the following equation:
wᵢ′=wᵢ*f(dᵢ)
wherein wᵢ′ is the data point's new weight; wᵢ is the data point's initial weight; and f(dᵢ) is the function that relates the weight of i^{th} data point to its distance from a given grid point.

8. The method of claim 7, wherein f(dᵢ) is selected from the group consisting of: a triangular, a bell, a trapezoidal, a harvesine, and an exponential function.

9. The method of claim 8, wherein the exponential function is a Gaussian function.

10. The method of claim 6, wherein the occurrence frequency for each atom type at each given grid point is calculated according to the following equation:
$${f}_{j} = {\sum }_{i = 1}^{n} {w}_{i}^{′}$$
wherein wᵢ′ is the adjusted weight of a data point; and n is the number of occurrences of an atom type in a grid point's effective radius.

11. The method of claim 6, wherein the spacing between grid points is 0.1-0.3 Å.

12. The method of claim 6, further comprising the step of calculating distribution densities at each given grid point.

13. The method of claim 12, wherein each distribution density is calculated according the following equation:
$${Q}_{i} = ln \frac{{f}_{j}}{{p}_{j}}$$
wherein Qⱼ is the distribution density factor of the j^{th} given grid point calculated separately for each atom type; fⱼ is the observed occurrence frequency for each atom type; and pⱼ is the expected occurrence frequency for each atom type at a grid point location j, calculated according to the equation:
$${p}_{j} = p * \frac{{\sum }_{j = 1}^{m} {\sum }_{l} {f}_{jl}}{m}$$
wherein p is the relative probability of occurrence for each atom type calculated based on statistical analysis of a sample of protein structures; fⱼₗ is the combined weight-adjusted frequency for all atom types l at the j^{th} given grid point; and m is the number of given grid points.

14. The method of claim 1, wherein the target protein is selected from the group consisting of Raf kinase, Rho kinase, NF-κB, VEGF receptor kinase, JAK-3, CDK2, FLT-3, EGFR kinase, PKA, p21-activated kinase, MAPK, JNK, AMPK, phosphodiesterase PDE4, Abl kinase, phosphodiesterase PDE5, ADAM33, HIV-1 protease, HIV integrase, RSV integrase, XIAP, thrombin, tissue type plasminogen activator, matrix metalloproteinase, beta secretase, src kinase, fyn kinase, lyn kinase, ZAP-70 kinase, ERK-1, p38 MAPK, CDK4, CDK5, GSK-3, KIT kinase, FLT-1, FLT-4, KDR kinase, and COT kinase.

15. A system for discovering a molecule with a binding affinity toward a protein target comprising: a processor; and a memory in electrical communication with the processor, wherein the processor is configured to carry out the method of claim 1.

16. A computer readable medium having computer readable program code embodied therein, wherein the computer readable program code causes the computer to carry out the method of claim 1.

17. A computer system comprising: a processor and a memory in electrical communication with the processor, wherein the memory has stored therein data indicative of a three-dimensional target protein binding site representation, comprising the binding site data set produced according to the method of claim 1.

18. A computer program product comprising a computer usable medium having computer readable program code comprising computer instructions for:
a) determining type and conformation of a plurality of amino acids of a ligand binding site on a three-dimensional target protein structure;
b) searching a structure database for amino acids matching the type and conformation of an amino acid of the binding site;
c) extracting three-dimensional coordinates of the atoms of a matched amino acid and atoms surrounding the matched amino acid into a coordinate set;
d) moving the coordinate set with respect to the searched amino acid until the matched amino acid is aligned with the searched amino acid;
e) assigning types and descriptors to the atoms of matched amino acids and atoms surrounding those matched amino acids, wherein the descriptors indicate that those atoms correlate with the searched amino acid; and
f) producing a binding site data set, wherein each data point of the set comprises coordinates and type of an atom surrounding a matched amino acid,
wherein the binding site data set is used for determining a candidate molecule's ability to bind a target protein.

19. A method executed by a computer under the control of a program, said computer including a memory for storing said program, said method comprising the steps of:
a) determining type and conformation of a plurality of amino acids of a ligand binding site on a three-dimensional target protein structure;
b) searching a structure database for amino acids matching the type and conformation of an amino acid of the binding site;
c) extracting three-dimensional coordinates of the atoms of a matched amino acid and atoms surrounding the matched amino acid into a coordinate set;
d) moving the coordinate set with respect to the searched amino acid until the matched amino acid is aligned with the searched amino acid;
e) assigning types and descriptors to the atoms of matched amino acids and atoms surrounding those matched amino acids, wherein the descriptors indicate that those atoms correlate with the searched amino acid;
f) producing a binding site data set, wherein each data point of the set comprises coordinates and type of an atom surrounding a matched amino acid,
wherein the binding site data set is used for determining a candidate molecule's ability to bind a target protein; and
g) repeating steps b) to d) for another amino acid of the binding site.

20. A computer implemented method for modeling a target protein binding site for determining a candidate molecule's ability to binding to the target protein binding site, comprising the steps of:
a) determining type and conformation of a plurality of amino acids of a ligand binding site on a three-dimensional target protein structure;
b) searching a structure database for amino acids matching the type and conformation of an amino acid of the binding site;
c) extracting three-dimensional coordinates of the atoms of a matched amino acid and atoms surrounding the matched amino acid into a coordinate set;
d) moving the coordinate set with respect to the searched amino acid until the matched amino acid is aligned with the searched amino acid;
e) assigning types and descriptors to the atoms of matched amino acids and atoms surrounding those matched amino acids, wherein the descriptors indicate that those atoms correlate with the searched amino acid;
f) producing a binding site data set, wherein each data point of the set comprises coordinates and type of an atom surrounding a matched amino acid,
wherein the binding site data set is used for determining a candidate molecule's ability to bind a target protein;
g) repeating steps b) to d) for another amino acid of the binding site;
h) superimposing a grid comprising a plurality of grid points and the binding site data set;
i) selecting all data points within a selected distance from a given grid point;
j) assigning a weight to each selected data point according to its distance from the given grid point; and
k) calculating an occurrence frequency for each atom type at each given grid point.
